(19) United States
(12) Patent Application Publication
(10) Pub. No.: US 2026/0110395 A1
(43) Pub. Date: Apr. 23, 2026

(54) MODULAR CLIPPING SYSTEM WITH ENHANCED LOCKING

(71) Applicant: Bowerbags, LLC, Dayton, OH (US)

(72) Inventor: James Patrick Bowerman, Dayton, OH (US)

(21) Appl. No.: 19/315,798

(22) Filed: Sep. 1, 2025

Related U.S. Application Data
(63) Continuation of application No. PCT/US2025/031565, filed on May 30, 2025.
(60) Provisional application No. 63/654,220, filed on May 31, 2024.

(51) Int. Cl. F16M 13/02; B60R 7/08; B60R 9/00; F16B 2/20

(52) U.S. Cl. CPC F16M 13/02; B60R 7/08; B60R 9/00; F16B 2/20

(57) ABSTRACT

A modular quick-release system, an equipment mounting system, a modular vehicle attachment system and a method of securing containers, bags or related articles to one another or other structure. The modular quick-release system has a peg and a clip assembly. The clip assembly includes a top cover, a handle, a base and a cradle. In one form, the modular clipping system is used to provide quick and secure engagement of the container, bag or related article to, and disengagement from, a torso-mountable webbing or a wall-mountable structure such as those found on a vehicle.

### CROSS REFERENCE TO RELATED APPLICATIONS

This application is a bypass continuation of International Application No. PCT/US2025/031565, filed May 30, 2025, entitled “MODULAR CLIPPING SYSTEM WITH ENHANCED LOCKING”, which claims the benefit of U.S. Provisional Patent Application Ser. No. 63/654,220, filed May 31, 2025, entitled “MODULAR CLIPPING SYSTEM WITH ENHANCED LOCKING”, the disclosures of which are hereby incorporated herein by reference.

### TECHNICAL FIELD

This disclosure relates generally to a modular clipping system for body-mountable or vehicle-mountable bags and related systems, and more particularly to a modular clipping system that includes enhanced locking in order to ensure a more secure connection to such bags and systems.

### BACKGROUND ART

Backpacks, rucksacks, knapsacks, and related load-carrying bags and containers may be carried in various manners by an individual, such as through torso-engaging straps. Relatedly, vests, flak jackets, body armor and related apparel are worn directly on the torso. In both cases, such bags and apparel could benefit from clipping devices in order to ensure that additional equipment that does not fit in or on the bag or apparel can still be carried while leaving a user's hands free for other activities. Typical clipping devices such as carabiners do not hold items tightly to the surface of the bag or apparel, while other clipping devices are limited to the specific types of surfaces to which they can attach. Moreover, to the extent that some clipping devices do perform properly under limited load conditions, they may not be robust enough to withstand rugged, everyday use under realistic conditions, particularly those encountered in military, police, tactical and related high-demand environments. As such, there is a need in the art for clipping systems that are secure, modular and capable of being used for a variety of bags, apparel and accessories, including those with webbing-based additional equipment attachment points.

### DISCLOSURE OF INVENTION

With the foregoing in mind, the author of the present disclosure has developed a system that promotes a fast and secure manner of removably attaching bags and related containers to wearable and vehicular-mounted surfaces. In one form, the system and methods disclosed herein include some or all of the components and associated functionality associated with the modular clipping system of U.S. application Ser. No. 17/885,303 entitled MODULAR CLIPPING SYSTEM which is hereby incorporated in its entirety by reference to the extent that such incorporation does not cause incompatibilities with the present disclosure.

In accordance with an aspect of the present disclosure, a modular quick release system includes a peg and a clip assembly. The peg includes a mounting surface from which a head and support shaft extend along a first axis of engagement, where the head forms a larger lateral surface area than the support post. The clip assembly has a proximal end, a distal end and a peg-receiving region disposed between these ends. The clip assembly includes a top cover, a handle, a base and a cradle. The top cover has resiliently-biased arms that are situated adjacent one another to define a top cover upper surface and which are pivotably secured to one another at a common location at or near the distal end. The arms define between them a cover opening that forms a portion of the peg-receiving region along the first axis of engagement. The handle is alignable with the top cover to move between the proximal and distal ends along a second axis of engagement that is orthogonal to the first axis of engagement. The handle includes a user-grippable first portion adjacent the proximal end and a second portion adjacent the peg-receiving region. The base is secured to the top cover and handle. The cradle defines a cradle opening. In this way, both the cradle opening and the cover opening are adjustably-sized and aligned with one another along the first axis of engagement to form a portion of the peg-receiving region. Both the cover opening and the cradle opening define a first aperture size when the arms are in a resilient bias state and a second aperture size when the arms are in a laterally displaced state relative to their resilient bias state. The first aperture sizes of each of these openings defines a smaller cross-sectional area than their respective second aperture size. The base and the handle are cooperative with one another such that upon movement of the handle toward the proximal end, the resilient bias state within the plurality of arms is overcome to cause the first aperture size of both the adjustably-sized cover opening and the adjustably-sized cradle opening to transition to their respective second aperture size such that the peg may be selectively inserted into or removed from the peg receiving region along the first axis of engagement along with corresponding engagement with or disengagement from the cradle.

In accordance with another aspect of the present disclosure, an equipment mounting system includes a track and a modular quick release system cooperative with the track. The track has an elongate peg-engaging channel along its lengthwise dimension with numerous engagement zones therealong. The modular quick release system includes a peg and a clip assembly. The peg includes a mounting surface from which extends, along a first axis of engagement, a support post that terminates in a removable head that defines a larger lateral surface area than the support post, wherein the support post and head are resiliently-biased relative to the mounting surface to permit selective movement of the support post and head along the first axis of engagement. The clip assembly has a proximal end, a distal end and a peg-receiving region disposed between them. In addition, the clip assembly includes a top cover, a handle, a base and a cradle. The top cover has arms situated adjacent one another to define a top cover upper surface. The arms are pivotably secured to one another at or near the distal end and are shaped to define a cover opening between them. The cover opening forms a portion of the peg-receiving region along the first axis of engagement. The handle is alignable with the top cover to move between the proximal and distal ends along a second axis of engagement that is orthogonal to the first axis of engagement. The handle includes a user-grippable first portion adjacent the proximal end and a second portion adjacent the peg-receiving region. The base is secured to the top cover and handle and defines a unitary structure with a lowermost extension along the first axis of engagement. The lowermost extension includes an axisymmetric-shaped outer surface and an inner surface that defines a non-axisymmetric-shaped fastener seating region such that upon engagement between the peg and clip assembly, the lowermost extension retains at least an upper portion of the head in the non-axisymmetric-shaped fastener seating region. The cradle defines a cradle opening therein that is aligned with the cover opening along the first axis of engagement to form a portion of the peg-receiving region. Both the cover opening and the cradle opening are adjustable to define a first aperture size when the arms are in a resilient bias state and a second aperture size when the arms are in a displaced state relative to their resilient bias state. The first aperture size of each of the respective cover and cradle openings defining a smaller cross-sectional area than the second aperture size, wherein the base and handle are cooperative with one another such that upon movement of the handle toward the proximal end, the resilient bias state is overcome to cause the first aperture size of both the cover and cradle openings to transition to their respective second aperture size. In this way, the peg may be selectively inserted into or removed from the peg receiving region along the first axis of engagement along with corresponding engagement with or disengagement from the cradle.

In accordance with yet another aspect of the present disclosure, an equipment mounting system includes a peg board, a peg and a modular quick release system. The peg board defines at least one aperture therein while the peg is securable to the peg board through the aperture. The peg includes a mounting surface from which extends, along a first axis of engagement, a support post that terminates in a removable head that defines a larger lateral surface area than the support post. The modular quick release system is securable to the peg board through the peg and includes a clip assembly having a proximal end, a distal end and a peg-receiving region disposed between the proximal and distal ends. The clip assembly includes a top cover, a handle, a base and a cradle. The top cover includes arms situated adjacent one another to define a top cover upper surface. The arms are pivotably secured to one another at or near the distal end and are shaped to define between them a cover opening that forms a portion of the peg-receiving region along the first axis of engagement. The handle is alignable with the top cover to move between the proximal and distal ends along a second axis of engagement that is orthogonal to the first axis of engagement. The handle includes a user-grippable first portion adjacent the proximal end and a second portion adjacent the peg-receiving region. The base is secured to the top cover and handle. The cradle defines a cradle opening therein that is aligned with the cover opening along the first axis of engagement to form a portion of the peg-receiving region. Both the cover opening and the cradle opening are adjustable to define a first aperture size when the arms are in a resilient bias state and a second aperture size when the arms are in a displaced state relative to their resilient bias state. The first aperture size of each of the respective cover and cradle openings defines a smaller cross-sectional area than the second aperture size. The base and handle are cooperative with one another such that upon movement of the handle toward the proximal end, the resilient bias state is overcome to cause the first aperture size of both the cover and cradle openings to transition to their respective second aperture size. In this way, the peg may be selectively inserted into or removed from the peg receiving region along the first axis of engagement along with corresponding engagement with or disengagement from the cradle.

In accordance with yet another aspect of the present disclosure, a modular vehicle attachment system includes a peg-shaped attachment and a securing mechanism formed on a surface of the peg-shaped attachment. The peg-shaped attachment includes a mounting surface from which extends, along a first axis of engagement, a support post that terminates in a removable head that defines a larger lateral surface area than the support post, wherein the support post and head are resiliently-biased relative to the mounting surface to permit selective movement of the support post and head along the first axis of engagement. The securing mechanism is formed on a surface of the peg-shaped attachment that is proximal relative to the head along the first axis of engagement.

### BRIEF DESCRIPTION OF DRAWINGS

The following detailed description of specific embodiments of the present disclosure can be best understood when read in conjunction with the following drawings, where like structure is indicated with like reference numerals and in which:

FIG. 1A depicts an upper perspective view of one embodiment of a modular quick release system (MQRS) in an assembled state where a first embodiment of a peg engages a clip assembly along a first axis of engagement;

FIG. 1B depicts a lower perspective view of the MQRS of FIG. 1A;

FIG. 1C depicts an upper perspective view of the clip assembly of the MQRS of FIGS. 1A and 1B with a pair of aligned apertures to define a peg-engaging region;

FIG. 1D depicts various components of an embodiment of the MQRS in a disassembled state;

FIG. 1E depicts a perspective view of the first embodiment of the peg in isolation;

FIG. 1F depicts a perspective view of a second embodiment of the peg in isolation;

FIG. 1G depicts a perspective view of the third embodiment of the peg in a disassembled state where the head is shown in two forms;

FIG. 1H depicts a perspective view of a third embodiment of the peg in isolation with one of the two heads of FIG. 1G;

FIG. 2A depicts a perspective view of the base, handle and locking assembly of the MQRS with the handle is extended along a second axis of engagement to expose an enlarged cradle opening;

FIG. 2B depicts a perspective view of the MQRS of FIG. 1B where the handle has been rotated approximately ninety degrees and no longer extended relative to the position of FIG. 2A to show its removability;

FIG. 2C depicts a side elevation view of the base, handle and locking assembly of the MQRS of FIGS. 2A and 2B where a pair of cooperating anvils form a cradle that makes up a portion of a peg engagement surface within the peg-receiving region;

FIG. 2D depicts a perspective view of the clip assembly in a partially assembled state just prior to the attachment of the top cover;

FIG. 3A depicts a top view of the various components of another embodiment of a portion of the clip assembly in a disassembled state;

FIG. 3B depicts a perspective exploded view of the embodiment of FIG. 3A that highlights different placement and shapes of the anvils that make up the cradle;

FIG. 4A depicts a view of a fully-assembled clip from the embodiment of FIG. 3A being secured to MOLLE-style webbing on a bag where the handle has yet to be extended along the second axis of engagement to show the cover opening and cradle opening with a first aperture size;

FIG. 4B depicts a fully-assembled view of the clip assembly of FIG. 3A being secured to the MOLLE-style webbing where a user is extending the handle along the second axis of engagement to show the cover opening and cradle opening with a second aperture size;

FIG. 5A depicts a perspective view of the various components of another embodiment of the MQRS in a disassembled state;

FIG. 5B depicts the MQRS of FIG. 5A in an assembled state;

FIG. 6A depicts a perspective view of the various components of another embodiment of the MQRS in a disassembled state, along with its relation to a third embodiment of the pegs of FIG. 1E;

FIG. 6B depicts the MQRS of FIG. 6A in an assembled state;

FIG. 6C depicts the MQRS of FIG. 6B attached to a logistics track (L-track), where at least a portion of the locking assembly is removed;

FIG. 6D depicts a perspective view of extensions that are used in conjunction with one version of the pages of FIG. 1E to engage the L-track of FIG. 6C;

FIG. 7A depicts a perspective view of the various components of another embodiment of the MQRS in a disassembled state where the first embodiment of the peg has been removed;

FIG. 7B depicts a top view of the MQRS of FIG. 7 attached to two adjacent rows of MOLLE-style webbing showing the cover opening and cradle opening with a first aperture size;

FIG. 7C depicts a perspective view of the MQRS of FIG. 7B just prior to engagement with one of the pegs of FIG. 1E that is separately secured to MOLLE-style webbing that is sewn into an accessory bag;

FIG. 8A depicts a pair of magnetic attachments and straps that form a part of a modular vehicle attachment system (MVAS),

FIG. 8B depicts a vacuum-based non-magnetic attachment that form a part of the MVAS;

FIG. 8C depicts an MQRS attached to the vacuum-based non-magnetic attachment of FIG. 8B;

FIG. 8D depicts details of a peg board with periodically-spaced pegs with which to secure numerous MQRS;

FIGS. 9A through 9C depict how bags and other equipment may be made to mount to vehicle using the MVAS;

FIGS. 10A and 10B depict how the MQRS of FIGS. 1A through 1E may be individually or jointly secured to a strap for use in securing bags, cases or related containers to a vehicle or to a MOLLE-style vest, jacket or related torso-mounted garment;

FIGS. 10C and 10D depict how the straps of FIGS. 10A and 10B may be used to secure bags, cases or related containers to a vehicle;

FIGS. 11A and 11B depict another embodiment of a peg;

FIG. 12A depicts the embodiment of the peg of FIG. 1F with an optional locking assembly in a closed position; and

FIG. 12B depicts the embodiment of FIG. 12A, now in an open position.

It will be appreciated that for the sake of clarity, elements depicted in the drawings are not necessarily to scale, and that certain elements may be omitted from some of the drawings. It will further be appreciated that certain reference numerals may be repeated in different figures to indicate corresponding or analogous elements.

### MODES FOR CARRYING OUT THE INVENTION

The author of the present disclosure has discovered that one technological difficulty to overcome relates to how to use a clip assembly that is both quick and easy to use while also providing enough durability to remain in place during use as well as withstand the types of harsh treatment that often accompany their use in certain types of tactical and recreational scenarios. Yet another part of this difficulty relates to how to make them universal enough to allow them to be easily configured for different types of mounting conditions. The present technical solution is to provide an MQRS and an MVAS that can overcome these difficulties through a robust, lightweight, inexpensive platform. In a more particular manner, the present technical solution may be adapted to different end-use needs, such as for bags or related containers that are meant to be torso-mounted or otherwise secured to an individual and those that are meant to be mounted to a vehicle or other rigid surface.

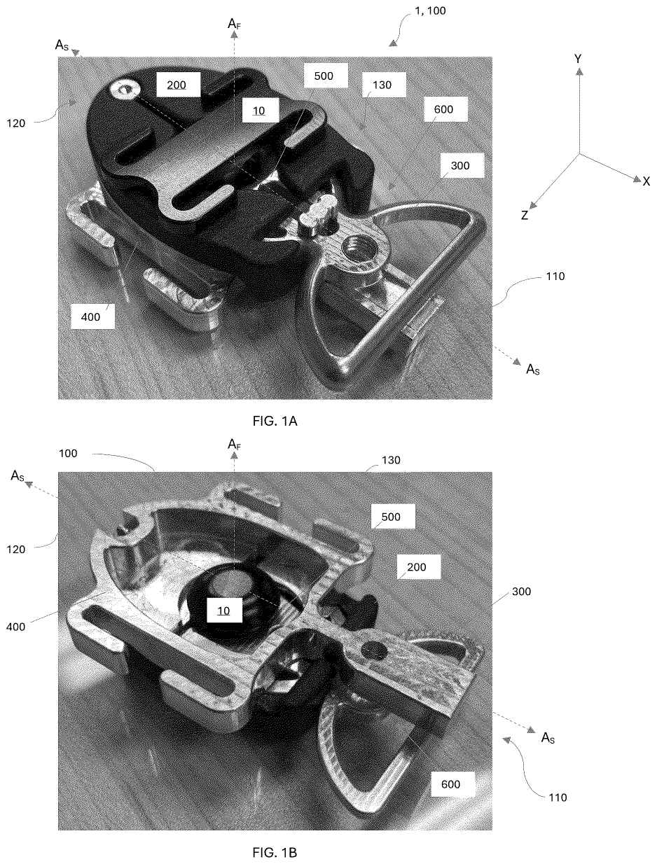

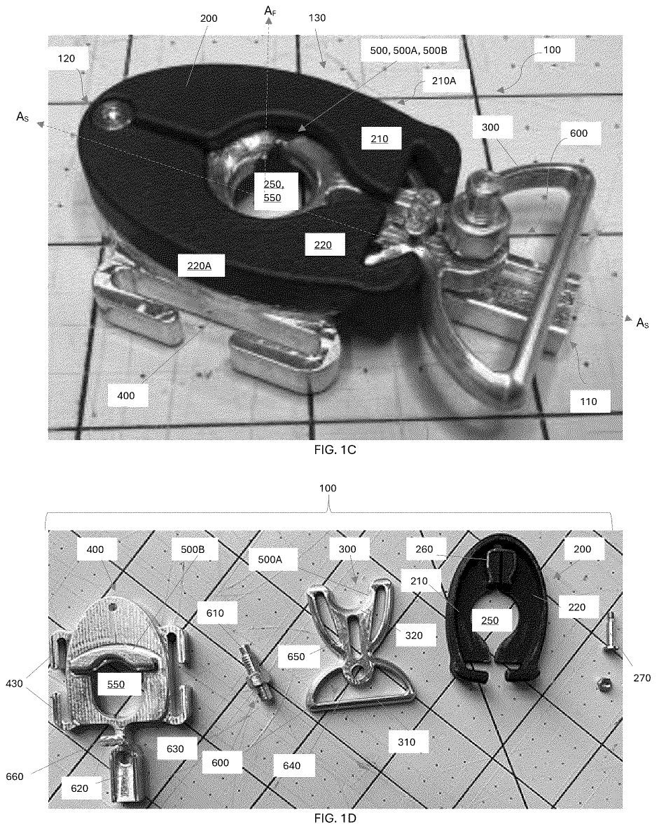

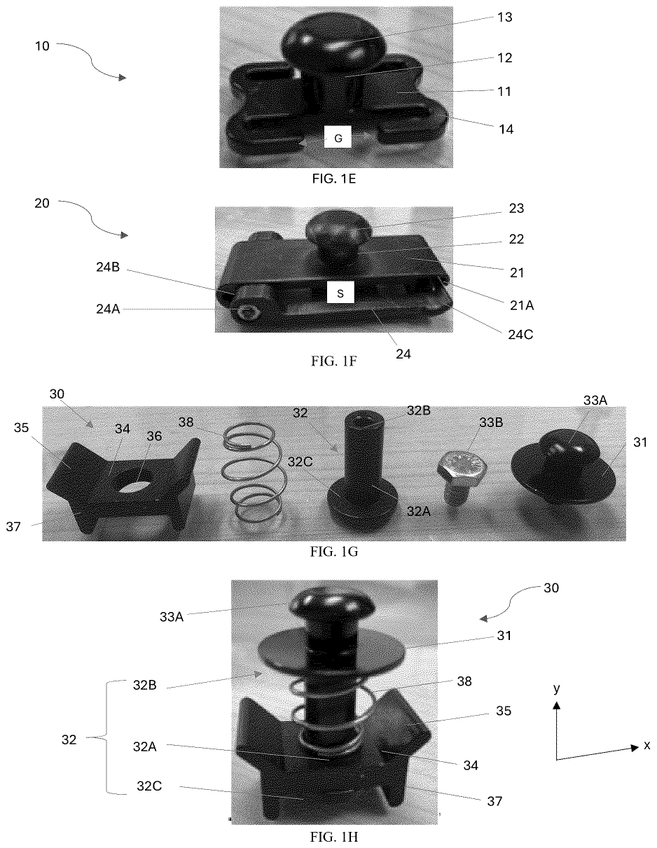

Referring initially to FIGS. 1A through 1H, various views of an embodiment of the MQRS 1 and corresponding modes of attachment are shown. The MQRS 1 includes various embodiments of a peg 10, 20, 30 and a clip assembly 100. The peg 10, 20, 30 includes a mounting surface 11, 21, 31, a support post 12, 22, 32, a head 13, 23, 33, and an engagement region 14, 24, 34 the last of which is configured to engage a piece of webbing (such as MOLLE-style webbing) for the embodiments of FIGS. 1E and 1F or a rail or other mounting structure for the embodiment of FIGS. 1G and 1H. The clip assembly 100 includes a top cover 200, a handle 300, a base 400, a cradle 500 and a locking assembly 600.

Referring with particularity to FIG. 1A, a perspective view of the MQRS 1 is shown. As can be seen, there are two primary axes of engagement of the MQRS 1: a first axis of engagement A_{F} and a second axis of engagement A_{S}, each defining a respective linear travel path that is orthogonal to the other. Within the Cartesian coordinate system shown, when the largest surface of the MQRS 1 is situated in plane that is generally formed by the X- and Z-axes, the first axis of engagement A_{F} extends vertically upward and downward along the Y-axis while the movement of the handle 300 extends within the plane along the second axis of engagement A_{S}. As will be explained in more detail elsewhere, the second axis of engagement A_{S} extends along the same general direction of the clip assembly 100 as the linear travel path of the handle 300 between a proximal end 110, an intermediate portion 130 and a distal end 120. As shown, the peg 10 has been placed into selective engagement with an upper surface of the cradle 500 along the first axis of engagement A_{F}; with such engagement, the cradle 500 forms a locking mechanism with the peg 10. In the present view, the locking assembly 600 is not engaged.

Referring with particularity to FIG. 1B, a view of clip assembly 100 that has been flipped upside-down about the X-axis to expose the underside reveals that, in one form, the base 400 is made up of a unitary structure (such as that which may be formed by casting, molding or other known manufacturing techniques) where various shapes, cutouts, cavities and other features related to the operation of the MQRS 1 may be seen. For example, the underside cavity creates a substantially open volume within which the head 13 of peg 10 may be selectively engaged with a lower surface of the cradle 500 along the first axis of engagement A_{F}. In one form, a lower surface (that is to say, one that faces vertically downward in the orientations depicted in FIGS. 1E though 1H) of the heads 13, 23, 33 is flat to provide a relatively large contact area between the heads 13, 23, 33 and the cradle 500. Portions of the locking assembly 600 are shown adjacent the proximal end 110 and which are also integrally formed with the base 400. In the form shown, when the handle 300, which is disposed along the first axis of engagement A_{F} between the base 400 and the top cover 200 to define a sandwich-like stacked structure, is in a non-extended position, a pair of apertures align with one another to form a part of the locking assembly 600 along an axis that is substantially parallel to the first axis of engagement A_{F}. This in turn permits the selective engagement of the locking assembly 600 that—when engaged—inhibits further movement of the handle 300 relative to the remainder of the clip assembly 100. As will be explained in more detail as follows, movement of the handle 300 back and forth along the second axis of engagement A_{S} when the locking assembly 600 is not engaged causes portions of the top cover 200 to assume either a resilient bias state or a displaced state.

Referring with particularity to FIG. 1C, a view of the MQRS 1 of FIG. 1A is shown where the peg 10 has been removed in order to better show a cover opening 250 that is formed in the top cover 200 and a cradle opening 550 that is formed in a region defined by the handle 300 and base 400, as well as some additional details of the cradle 500. As discussed elsewhere, the aligned cover opening 250 and cradle opening 550 forms a portion of the peg-receiving region that resides in the intermediate portion 130 along the first axis of engagement A_{F}. Likewise as discussed elsewhere, the size of the cover opening 250 and the cradle opening 550 may be varied based on movement of the handle 300 relative to the remainder of the clip assembly 100 along the second axis of engagement A_{S} that in turn causes cooperating anvils 500A, 500B to either move closer to or farther away from one another. Unlike FIG. 1A, the locking assembly 600 is presently engaged in FIG. 1C, showing how a locking pin 610 is placed within the aligned cover opening 250 and cradle opening 550 in order to retrain the movement of the handle 300 relative to the base 400 that in turn maintains a pair of arms 210, 220 that are situated adjacent one another to define an upper surface of the top cover 200 at or near the distal end 120 of the clip assembly 100. In one form, the arms 210, 220 are configured to maintain a relative side-by-side spacing between them through one or more resilient bias mechanisms, such as through integral formation of the top cover, through a supplemental spring or the like, as will be discussed in more detail herein. As will be seen in FIG. 1D and elsewhere, the locking pin 610 is threaded along at least a portion of its elongate dimension to enhance its locking functionality with a companion threaded surface of an aperture formed within the base 400.

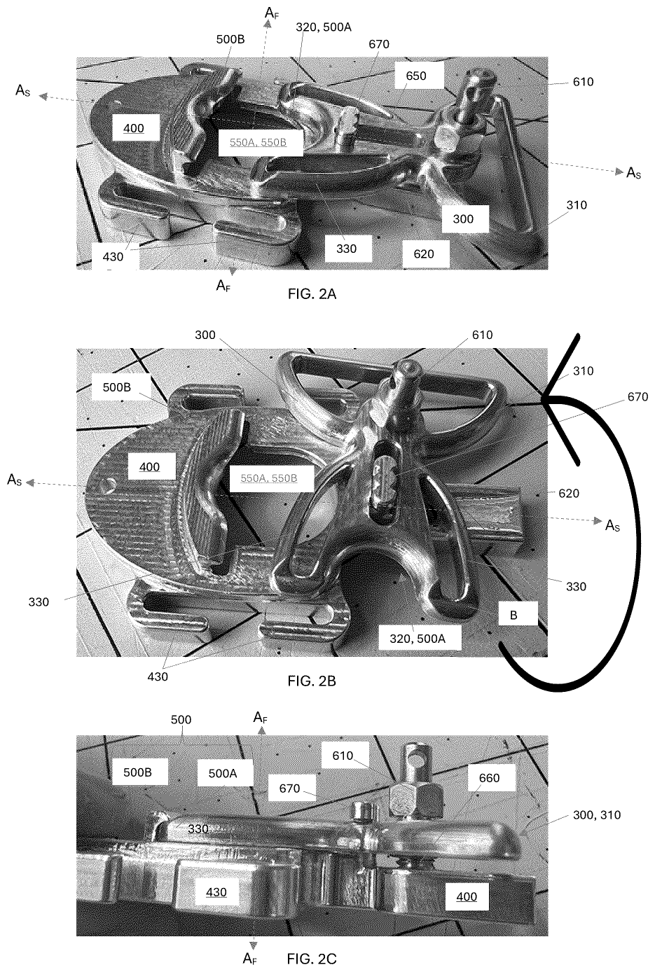

The pair of anvils 500A, 500B (hereinafter described as a first anvil 500A and a second anvil 500B) each define a beveled upper surface B along the first axis of engagement A_{F}. In the present context, the bevel B that is formed on the upward-facing surfaces of the anvils 500A, 500B need not itself define a planar surface, but may also include surfaces with a slight curvature, such as those to generally match the contour of the head 13, 23, 33 of the corresponding peg 10, 20, 30 to which the cradle opening 550 is configured to engage. As will be discussed later, the cooperation of the contours of the head 13, 23, 33 and the bevel B (and the resulting lateral force that it imparts to the anvils 500A, 500B when the size of the aperture defined by the anvils 500A, 500B is of smaller dimension than the head 13, 23, 33) may be useful in helping to insert the heads 13, 23, 33 into one or both of the cover opening 250 and the cradle opening 550, particularly in so-called “brute-force” situations where a user may not be willing or able to take the time or effort to pull the handle 300 of the MQRS 1. As shown, when the pair of arms 210, 220 are in their resilient bias state (that is to say, when they haven't been pulled apart under the overcoming force being generated by pulling the handle 300 along the second axis of engagement A_{S}), the first and second anvils 500A, 500B substantially abut one another to give the cradle opening 550 a generally circular cross-section when viewed along the first axis of engagement A_{F}. Relatedly, by defining an integral connection of the generally elongate body of the top cover 200 at just one end where the two arms 210, 220 join up with one another, a spring-like elastic bias is formed in the top cover 200. In this way, the two arms 210, 220 cooperate to return the top cover 102 to its natural state in response to any attempt to force the arms 210, 220 to splay apart in a direction transverse to their elongate dimension. In this configuration, the screw 270 acts as a pivoting anchor at the distal end so that the arms 210, 220 can be moved between an opened position where they are apart from each other at their proximal ends, and a closed position where they are adjacent one another at their proximal end. The top cover 200 has a distal end that has a through-hole that retains the screw 270, and a distal end. The proximal end of each arm 210, 220 can have a projection that forms a grip and also forms a channel between the two arms 210, 220 when in the closed position. That enables the user to better grip the arms 210, 220, if needed, and move the arms 210, 220 apart at the proximal end to pivot about the screw 270. As shown, in one form the top cover 200 is a thin plate that forms a top surface, while each of the arms 210, 220 define a corresponding downwardly-turned side wall 210A, 220A that extends about at least a portion of the outer perimeter of the cover plate. These side walls 210A, 220A are configured to press against a pair of curvaceous levers 330 (not presently shown, but exposed in FIGS. 2A through 2D) that make up a portion of the handle 300 such that the elastic bias that is present in the arms 210, 220 provides a restoring force to the top cover 200 that in turn enables it to—at rest—assume the resilient bias state (and corresponding shape) shown in FIGS. 1A through 1C. As will be discussed elsewhere, when the handle 300 is pulled to overcome the resilient bias state of the arms 210, 220, the first and second anvils 500A, 500B move away from one another along the second axis of engagement A_{S}, resulting in cradle opening 550 that defines a more oblong cross-sectional shape when viewed along the first axis of engagement A_{F}.

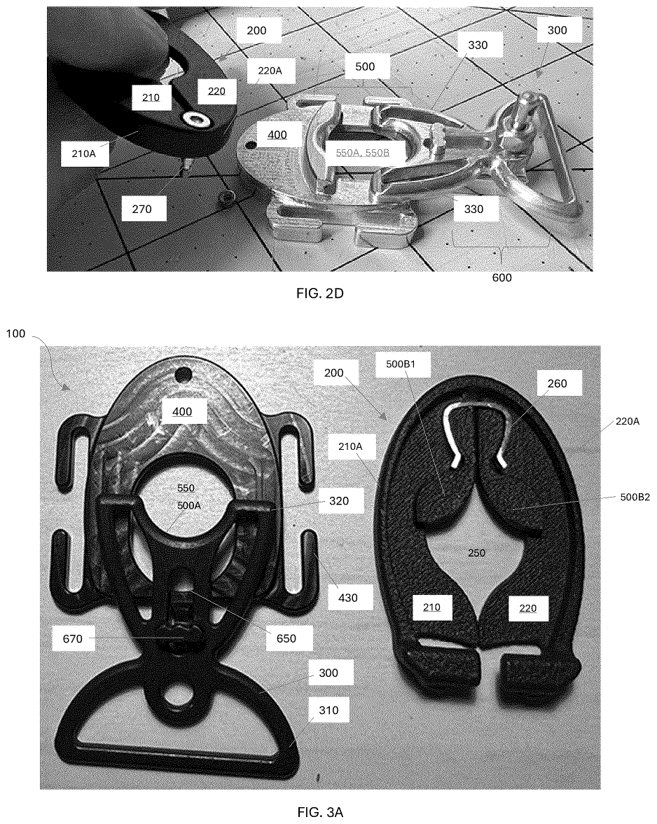

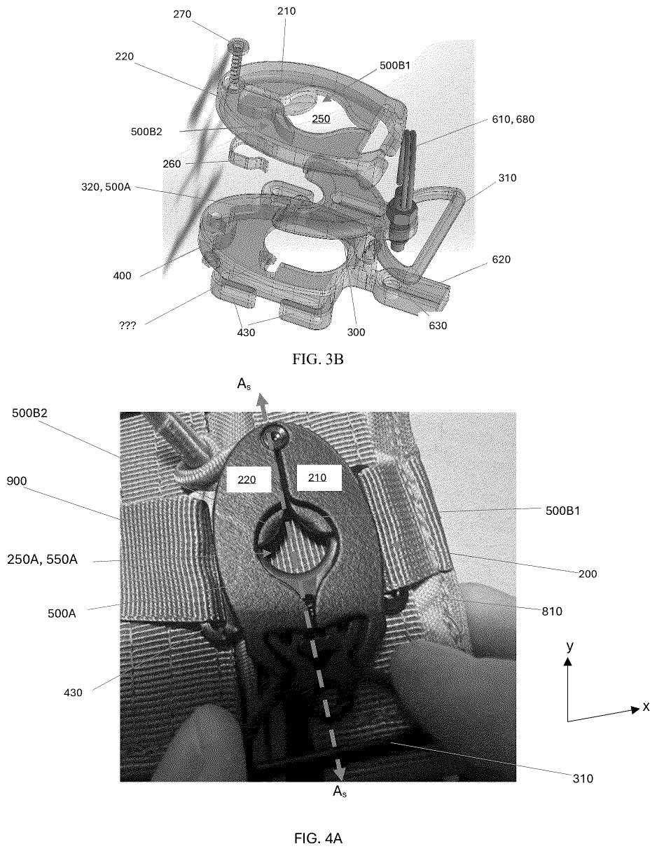

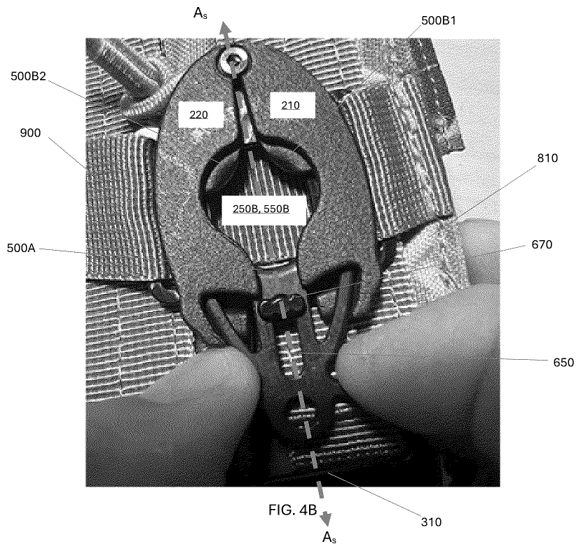

Referring with particularity to FIG. 1D, various components that make up the clip assembly 100 are shown, including (from left to right) the base 400, the cradle 500 (with its first and second anvils 500A, 500B), the locking assembly 600, the handle 300 (with its user-grippable first portion 310 adjacent the proximal end 110 of the clip assembly 100 and second portion 320 adjacent the second anvil 500B), the top cover 200 (with a with a bias spring 260 shown in its inserted position adjacent a distal end of the top cover 200) and a screw 270 with cooperating nut. It will be appreciated by one of ordinary skill in the art that while the screw 270 and its companion nut are shown, any type of fastener may be used to assemble the top cover 200 to the reset of the clip assembly 100. In the form shown, the first anvil 500A is integrally formed as part of the handle 300 to define a curved surface of the second portion of handle 300, while the second anvil 500B is integrally formed as part of the base 400 to define a curved surface such that the two anvils 500A, 500B may be brought into substantial contact with one another as a result of moving the handle 300 along the second axis of engagement A_{S} toward the distal end 120 of the clip assembly 100. As shown, the first anvil 500A resides substantially within a plane second anvil 500B may, while the second anvil 500B projects upwardly out of the plane of the base 400 along the first axis of engagement A_{F}. In another form that will be shown in FIGS. 3A, 3B, 4A and 4B, the second anvil 500B may be integrally formed as part of the top cover 200 in general and the arms 210, 220 in particular. In this latter form, the second anvil 500B may more closely resemble the first anvil 500A insofar as it is formed predominantly in a plane defined by the top cover 200. Continuously curved surfaces formed on the handle 300 that extend at least part ways between its user-grippable first portion 310 and the anvil-defining second portion 320, in cooperation with contacting inward-facing side walls of the arms 210, 220 when the user pulls on the handle 300, the side walls that are situated in the intermediate portion 130 of the clip assembly 100 in general and the handle 300 in particular pushes outwardly on the side walls 210A, 220A of the top cover 200, thereby forcing the arms 210, 220 to splay apart within a plane defined by the arms 210, 220. As previously noted, this outward splaying motion is opposed by the elastic bias that is inherently formed between the two arms 210, 220.

As can be seen, various individual components make up the locking assembly 600, including the aforementioned locking pin 610, a locking surface 620 formed within the handle 300, a base aperture (also referred to as a pin-receiving aperture) 630 formed in the locking surface 620 and extending therethrough along the first axis of engagement A_{F}, a handle first aperture 640 that, in a manner analogous to the base aperture 630, extends through the handle 300 along the first axis of engagement A_{F}, a handle second aperture 650 that defines an elongate channel within the handle 300 along the second axis of engagement A_{S}, and a locking mount 660 that is formed as part of the base 400. In one form, one or more of the handle 300, base 400, cradle 500, locking assembly 600 and certain ancillary parts (such as springs, screws or the like), as well as the pegs 10, 20, 30 of FIG. 1E, may be made from rigid structural materials, including those based on lightweight aluminum or other metals, as well as certain polymers, while the top cover 200 (in general) and the arms 210, 220 (in particular) may be made from a tough, bendable polymer.

In the embodiment of the base 400 that is depicted in FIGS. 1A through 1D, it can be seen that in addition to the base 400, the handle 300 may define a unitary, integrally-formed construction (such as through casting or known joining techniques). A pair of web clasps 430 extend laterally from the base 400 on opposing sides. Within the present disclosure, such lateral extension is understood to extend in a direction orthogonal to the second axis of engagement A_{S} yet within generally the same plane as the remainder of the base 400. As will be discussed in more detail elsewhere, the web clasps 430 are useful in one form to secure the MQRS 1 (or a bag, pack, container or other structure secure thereto) to one or more rows or columns of MOLLE-style webbing.

Referring with particularity to FIGS. 1E, 1F, 1G and 1H, different embodiments of the pages 10, 20, 30 are shown. For example, in FIG. 1E the peg 10 includes a mounting surface 11, a support post 12 that extends along the first axis of engagement A_{F} to terminate in a head 13 that has a larger lateral surface area than the support post 12, and a pair of web-engaging extensions 14 that extend laterally away from the mounting surface 11. As shown, the web-engaging extensions 14 are made up of arms that have a gap G between their termination points in order to promote the insertion or removal of a pinched (or puckered) portion of web (not presently shown) through the gap G and into a channel for structural engagement or disengagement with the peg 10. Thus, once the force that is being applied to cause the pinching is removed, the web will (if inserted through the gap G to be within the channel) remain secured within the web-engaging extensions 14, while the web will (if inserted through the gap G to be removed from the channel) become decoupled from the web-engaging extensions 14. Although not shown, it will be appreciated that in another form, no such gap G exists such that the web-engaging extensions 14 such that the arms form a continuum to provide the channel with an elongate closed aperture. In this latter configuration, the pinching operation that produces the pucker in the web cannot be used; instead, engagement and disengagement of the web and the web-engaging extensions 14 takes place between the elongate closed aperture and the end of the web in a manner similar to threading the eye of a sewing needle. Both versions are deemed to be within the scope of the present disclosure. In any event, once the peg 10 is secured to a web, the peg 10 is ready to use for the mounting or dismounting of an MQRS-equipped bag or other container (neither of which is presently shown) through the cover opening 250 and cradle opening 550 that are formed in the clip assembly 100. Within the present disclosure, this embodiment is referred to as a version A embodiment.

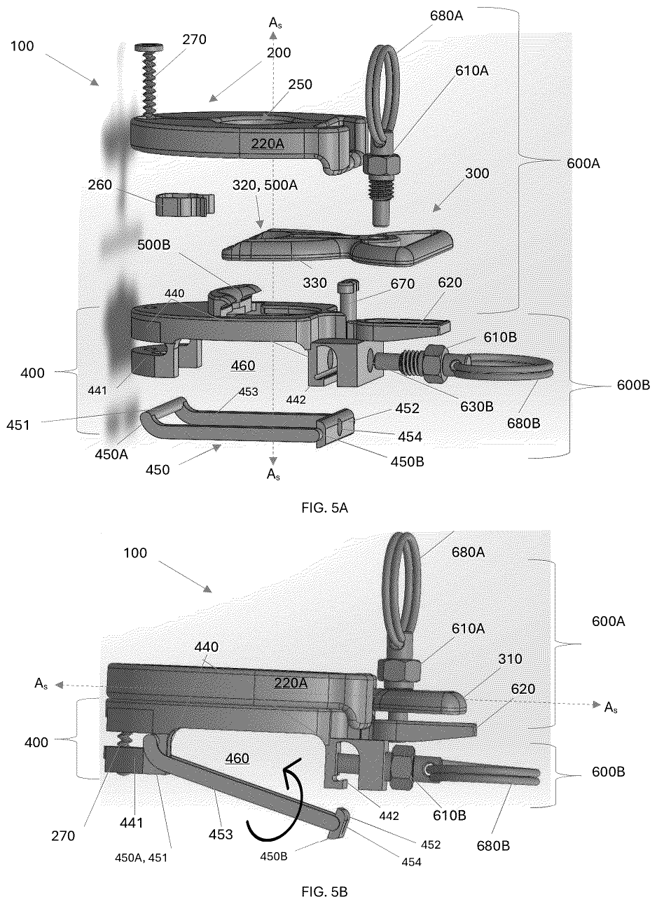

Likewise, in FIG. 1F the peg 20 includes a mounting surface 21 and a support post 22 that extends along the first axis of engagement A_{F} to terminate in a head 23 that has a larger lateral surface area than the support post 22. Instead of the pair of web-engaging extensions 14 of the version A embodiment that extend laterally away from the mounting surface 21, the present embodiment includes a hinged clamp 24 with which to wrap around a web (not presently shown). As can be seen, the mounting surface 21 and the hinged clamp 24 form an elongate slot S that when viewed from the side defines a thin rectangular cross-section. The hinged clamp 24 includes a pivot 24A that provides the clamp 24 with rotational movement about the axis of the pivot 24A, while a lengthwise exaggerated cavity 24B that is formed in a volumetric space around the pivot 24A allows the pivot 24A to have a small amount of translational movement as well in a direction that extends between the lengthwise exaggerated cavity 24B and a detent 24C. Rotational movement of the pivot 24B allows the peg 20 to be fit around a web (such as the aforementioned MOLLE-style webbing), while the translational movement of the pivot 24A and the cooperation between the detent 24C and a latching surface 21A that projects downward from a lower portion of the mounting surface 21. The elongate dimension of the hinged clamp 24 is such that it does not permit decoupling of the peg 20 from the MOLLE-style webbing once engaged and locked into place. In one form, the detent 24C that is at the end of the hinged clamp 24 that is opposite the pivot 24A may be slightly J-shaped in order to selectively couple to the latching surface 21A. Within the present disclosure, this embodiment is referred to as a version B embodiment, and as will be discussed in conjunction with FIGS. 5A and 5B, defines a generally similar mode of interaction with the MOLLE-style webbing discussed elsewhere. As will be shown and discussed in conjunction FIGS. 12A and 12B, the version B embodiment that utilizes a peg similar to peg 20 may include a locking assembly 1600 that is generally similar to the locking assembly 600 such as is shown in FIGS. 5A and 5B.

Moreover, in FIGS. 1G and 1H the peg 30 includes a mounting surface 31, a support post 32 that extends along the first axis of engagement A_{F} to terminate in one of two interchangeable heads 33 (generally) and 33A (specifically, which resembles the cradle-engaging portions of the pegs 10 and 20) and 33B (specifically, which resembles a screw or hexagonal-headed threaded bolt) both of which has a larger lateral surface area than the support post 32. As can be best seen, the support post 32 has a proximal end 32A that is closest to the mounting surface 31 and a distal end 32B that is closest to the head 33. As shown, the support post 32 defines a tubular structure such that an inner surface includes threads along its elongate dimension. Both heads 33A, 33B include along their elongate dimension a threaded surface that is sized to cooperate with the threaded inner surface of the support post 32 so that the heads 33A, 33B may be interchanged, depending on the end use. In one form (ss shown) the mounting surface 31 defines a washer-like surface that has a larger surface area than the support post 32 or head 33.

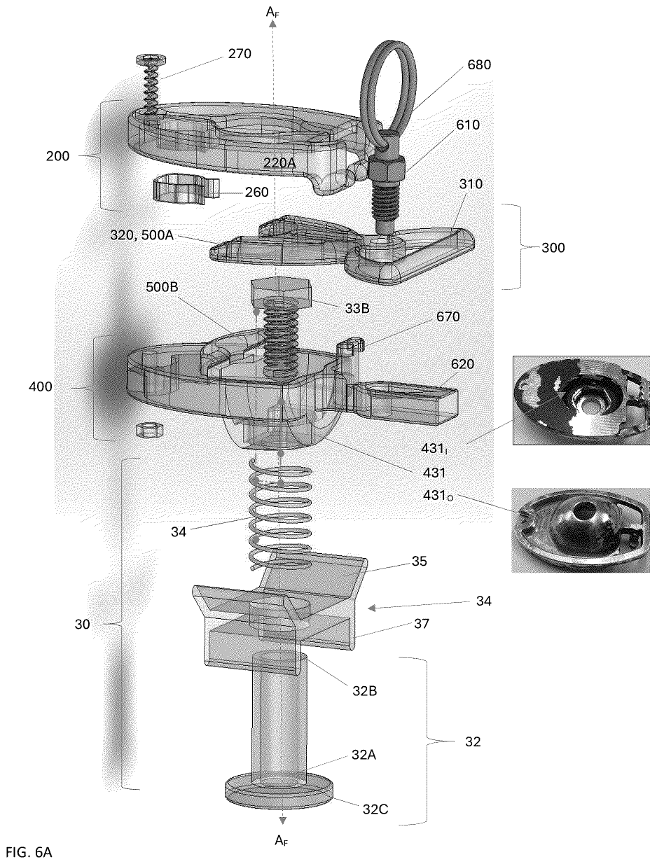

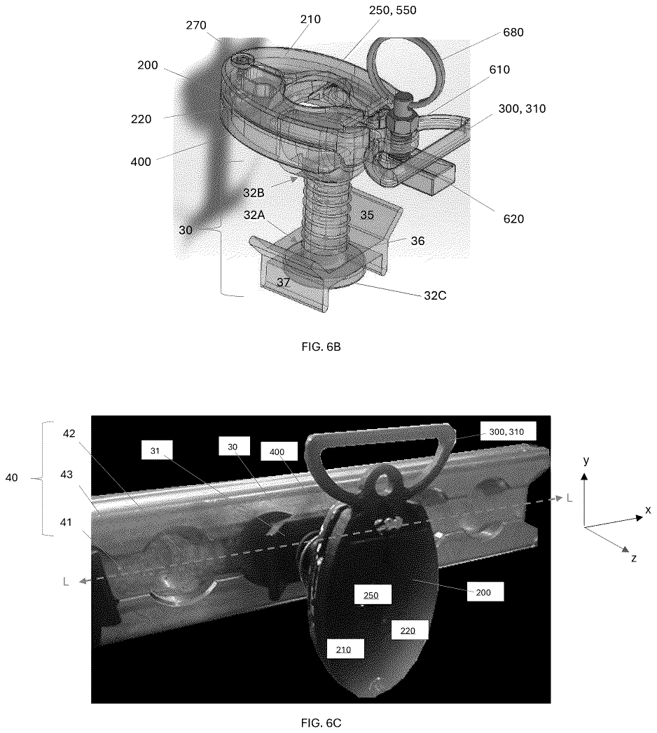

As with the engagement region 24 of the embodiment of FIG. 1F, the engagement region 34 of FIGS. 1G and 1H is adjustable. In this latter embodiment, the engagement region defines an irregular-shaped body with user-graspable handles 35, an aperture 36, downwardly-projecting legs 37 and a bias member in the form of a coil spring 38. As shown with particularity in FIG. 1H, the aperture 36 allows the insertion or removal of the support post 32 through the engagement region 34 along the first axis of engagement A_{F}. A stop 32C that is integrally formed adjacent the proximal end 32A of the support post 32 and of greater lateral dimension than the aperture 36 limits the upward (that is to say, y-axis as shown) travel of the support post 32 along the first axis of engagement A_{F}, while a coiled spring 38 biases the support post 32 and head 33 to push them in the vertically upward direction shown, thereby seating the stop 32C against the portion of a lower surface of the mounting surface 31 that surrounds the aperture 36. This has the effect of placing the peg 30 in an at-rest locked position for engagement with a cooperating slot, channel or related surface. When a user desires to disassemble the peg 30 (such as to replace one of the heads 33 with the other), the user need merely rotationally twist the head 33 relative to the support post 32 in order to coax the head 33 away from its threaded attachment to the support post 32. Contrarily, when a user desires to secure the peg 30 (such as to a track or other mounting surface that will be discussed in more detail in conjunction with FIGS. 6A through 6D), the user merely grasps the handles 35 (such as with a forefinger and middle finger) and presses the head 33 in a downward direction (such as with the thumb) that coincides with the first axis of engagement A_{F} in order to overcome the bias in the coiled spring 38. In this way, the peg 30 enjoys a freedom of movement relative to the structure to which it needs either to be mounted to or removed from a rail, track or other structure as discussed herein. Within the present disclosure, this embodiment is referred to as a version C embodiment.

Referring next to FIGS. 2A through 2D, the clip assembly 100 of FIGS. 1A through 1C is shown prior to full assembly, along with rotatability of the handle 300 and engagement of two anvils 500A, 500B that form part of the cradle 500. Compared to the views of the clip assembly 100 from FIGS. 1A through 1D, the removal of the top cover 200 from FIGS. 2A through 2D allows additional details of this embodiment of the MQRS 1 to be seen. Significantly, the placement and operation of the two anvils 500A, 500B that form part of the cradle 500 that correspond to this embodiment may be seen clearly.

Referring with particularity to FIG. 2A, a perspective view of the various components of the MQRS 1 in a partially disassembled state with the top cover 200 removed is shown.

Referring with particularity to FIG. 2B, the MQRS 1 of FIG. 2A is shown where the handle 300 is replaceable though its ability to both rotate about an axis that is parallel to the first axis of engagement A_{F} as well as translate relative to the base 400 about a second axis of engagement A_{S}. The handle second aperture 650, which is made to accept the locking mount 660 that is formed as part of the base 400, may be rotated so that it may be lifted over the locking mount 660 upon alignment of the wider dimension of the locking mount 660 with the longer dimension of the handle second aperture 650.

Referring with particularity to FIG. 2C, the side elevation view shows how the two anvils 500A, 500B are in a facingly-adjacent position relative to one another while the handle 300 and base 400 are in a position that corresponds to the resilient bias state of the (presently not shown) arms 210, 220 of the top cover 200. In particular, the first anvil 500A that forms a part of the handle 300 is now engaged with the second anvil 500B of the base 400 to form the cradle 500 that makes up a portion of a peg engagement surface that defines the region that includes the cover opening 250 and cradle opening 550. In this way, the handle 300 is docked or housed when it is in a fully closed position to maintain a secure enclosure for one of the pegs 10, 20, 30 when force is applied in the first axis of engagement A_{F}. In particular, this arrangement keeps the handle 300 from becoming disengaged that in turn may otherwise cause the top cover 200 to break. In one form, the first and second anvils 500A, 500B may be integrally formed (such as through casting or the like) with their respective handle 300 and base 400 in order to form a unitary piece of structure. Likewise, the coupling between the anvils 500A, 500B and their respective handle 300 and base 400 may be made to mimic integral formation, such as through the use of suitable fasteners, adhesives or other known joining techniques. As previously discussed, the size of the cover opening 250 and the cradle opening 550 may be made larger or smaller based on movement of the cooperating anvils 500A, 500B in response to movement of the handle 300 relative to the remainder of the clip assembly 100 along the second axis of engagement A_{S}. Both the removable locking pin 610 and the aperture 630 defined within the locking mount 620 define respective threaded surfaces along at least a portion of their respective lengths so that they may threadably engage each other. When engaged in this manner, the handle 300 becomes immobilized. Such immobilization prevents relative movement between the handle 300 and the base 400 in both the first axis of engagement A_{F} and the second axis of engagement A_{S}.

Referring with particularity to FIG. 2D, the top cover 200 is shown just prior to being threadably secured to the base 400. As can be seen, the arms 210, 220 in general and their respective side walls 210A, 220A in particular are formed of a unitary (that is to say, integrally-formed) construction with sufficient restorative force such that any attempt to splay the arms 210, 220 apart (such as through a pivotal swinging motion of their respective ends that are opposite of ends where the screw 270 resides) is resisted, thereby causing the top cover 200 to return to the shape depicted in FIGS. 1A through 1D and 2D. As discussed elsewhere, it is the force that is imparted to the side walls 210A, 220A by a pair of curvaceous levers 330 that make up a portion of the handle 300 when pulled along the second axis of engagement A_{S} that constitutes such an attempt.

By the construction of the cradle 500 and its corresponding opening 550 in the manner depicted in FIGS. 2A through 2D as well as elsewhere in the present disclosure, avoids having a user to perform a swooping J-shaped motion along the first axis of engagement A_{F} while attempting to remove the peg (such as pegs 10, 20, 30) from the clip assembly 100. In other words, without having the presently-disclosed cradle 500 construction, the user would have to push the peg (again, such as one of pegs 10, 20, 30) into a clip in order to release it from its cradle and then follow that up with the J-shaped swoop motion to allow the peg to separate from the from clip. By contrast, with the system of the present disclosure, opening the handle 300 first allows the user to remove the peg 10, 20, 30 out from the clip assembly 100. In this manner, the cradle 500 has a built-in safety feature built into the base while reducing peg-to-clip complexity.

Referring next to FIGS. 3A and 3B, another embodiment of the MQRS 1 is shown. Unlike the embodiment of FIGS. 1A through 2D, the present embodiment adjusts the placement and operation of anvil 500B. In particular, while the placement and operation of the anvil 500A that is formed as part of the second portion 320 of handle 300 remains substantially the same, the placement and operation of the anvil 500B differs in that it is formed as extensions of the arms 210, 220 that make up the top cover 200. In operation, whereas the anvil 500B of the embodiment of FIGS. 1A through 2D remained stationary with the base 400, the extensions (which are labeled as 500B1 and 500B2, respectively) that are depicted in FIGS. 3A and 3B move in a pivoting manner along with their corresponding arms 210, 220 in response to the contact forces that are imparted to the side walls 210A, 220A by the action of the curvaceous levers 330. FIG. 3A shows with particularity the top cover 200 and base 400 in isolation, while FIG. 3B shows an exploded view of these two components along with the handle 300 and the locking assembly 600.

Referring next to FIGS. 4A and 4B, the embodiment of the MQRS 1 that is using the clip assembly 1100 of FIGS. 3A through 3G is depicted in an assembled state, along with its attachment to a MOLLE-configured torso-mounted bag 800A. As can be seen, the torso-mounted bag 800A has one or more rows and columns of MOLLE-style webbing 810 sewn into the torso-mounted bag 800A. It will be appreciated that other forms of connection of the MOLLE-style webbing 810 to the torso-mounted bag 800A are also within the scope of the present disclosure, including the use of fasteners, adhesives, integral formation or the like.

Referring with particularity to FIG. 4A, a view of a fully-assembled clip from the embodiment of FIG. 3A being secured to a row of the MOLLE-style webbing 810 is shown. In this view, the handle 300 has yet to be extended along the second axis of engagement A_{S} to show the cover opening 250 and cradle opening 550 both in a first aperture size 250A, 550A. Within the present disclosure, terms such as “rows” and “columns” will be understood to respectively describe components or axes that during normal use are oriented to generally align with horizontally-extending and vertically-extending directions in conventional Cartesian space. For example, when the torso-mounted bag 800A is worn by an individual who is in an upright sitting or standing position, the rows of MOLLE-style webbing extend along the X-axis while the columns extend along the Y-axis, as shown.

Referring with particularity to FIG. 4B, the handle 300 is being extended along the second axis of engagement Aₛ. Thus, upon movement of the handle 300 along the linear travel path defined by the second axis of engagement A_{S} toward the proximal end 110, the resilient bias state within the plurality of arms 210, 220 of the top cover 200 is overcome by the pair of curvaceous levers 330 of FIGS. 2A through 2D to cause the first aperture size 250A within the top cover 200 to transition to the second aperture size 250B and removal of the overhanging interference fit between the first and second anvils 500A, 500B of the cradle 500 such that the peg (not presently shown, but configured to be any of the pegs 10, 20, 30 of FIGS. 1E and 1F) may be selectively inserted into or removed from the peg-receiving region along the first axis of engagement A_{F}. In one form, the contact between the first and second anvils 500A, 500B defines a pair of sloped or faceted contact surfaces. In a similar manner, the movement of the handle 300 along the linear travel path defined by the second axis of engagement A_{S} toward the proximal end 110 causes the first and second anvils 500A, 500B to move away from one another, thereby transitioning the first aperture size 550A of the cradle 500 to the second aperture size 550B.

The embodiments depicted in FIGS. 3A through 4B help to demonstrate how attributes of the cradle 500 may be deployed, either in a hybrid configuration or almost exclusively in or on the top cover 200. In this way, a so-called “activate and open” action (as depicted in FIGS. 4A and 4B) takes place when the handle 300 is pulled into an open position in that the peg (10, 20, 30) can release from the clip assembly 100 without having to use the previously-discussed push in, J-shaped swoop motion. In a variation, the top cover 200 continues to have generally equal protrusions from both sides but also contains protrusions from the base 400 on its left and right sides to create a housing for the handle 300 when in a closed position, thereby providing a secure enclosure around the peg (not presently shown) when in the MQRS 1 is in a closed position. Thus, not only does it ensure a high degree of peg-to-clip security while in a closed position but also creates a more full opening with which to release the peg (10, 20, 30) from the clip assembly 100 when the handle 300 is moved to an open position. In a similar manner, a hybrid version of cradle 500 construction would provide a middle ground between providing maximum load retention and a user expectation that the peg 10, 20, 30 is easily able to be released from the clip assembly 100 in a fully opened position.

Referring next to FIGS. 5A and 5B, a clip assembly according to another aspect of the MQRS 1 is shown. Unlike the previously-discussed embodiments, the locking assembly 600 may be situated in one of two different locations; in this embodiment, the locking assemblies are designated 600A and 600B. In particular, in the upper portion of FIGS. 5A and 5B, the locking assembly 600A resembles a location and spatial orientation similar to that already discussed, while the lower portion of FIGS. 5A and 5B show the locking assembly 600B situated in a location that occupies a lowermost section of the base 400 and which is spatially oriented to extend horizontally rather than vertically. It will be appreciated that—depending on the end use—one or the other (or even both) of these configurations may be used.

Referring with particularity to FIG. 5A, a perspective exploded view of the various components of the clip assembly 100 are shown in a disassembled state. In general, the top cover 200, handle 300 and cradle 500 are the same as the embodiments of FIGS. 1A through 3B; it is mostly the base 400 (as well as the potential for a different and locking assembly 600B) that includes significantly different features. For example, the manner in which the base 400 connects to a web (such as the aforementioned MOLLE-style webbing) uses a multi-piece construction such that a structure defined thereby includes a sled-shaped tray 450 with a first end 450A and a second end 450B. The tray 450 may be pivotally attached to a pair of engaging regions 440 that are formed on the lower surface of the base 400. Secure coupling between the tray 450 and the pair of engaging regions 440 is achieved at one end through a slotted pivot mount 441 that accepts a crossbar 451 that is formed in the tray 450, and at the other end by a clasp 442 that secures a detent 452 at the other end in a manner similar to the J-shaped cooperation between the latching surface 21A and detent 24C of the hinged clamp 24 of FIG. 1F. When viewed along a side elevation, the cooperation of the tray 450 and the pair of engaging regions 440 forms a generally rectangular-shaped volume that corresponds to a web-engaging channel 460 therebetween. The size and shape of this web-engaging channel 460 is such that the MOLLE-style webbing discussed elsewhere may fit inside or pass through in order to promote the bag, container or other article modes of attachment depicted in this disclosure. In one embodiment, an aperture 454 formed in the end of the detent 452 is configured to align with the aperture 630 that is formed in a supplemental (or alternatively) or replacement locking assembly 600B. In this way, the locking assembly 600B may, through locking pin 610B, securely connect the various components of the MQRS 1 in place as previously discussed. The tray 450 may assume various forms, depending on the end use need. As shown, it includes a pair of side rails 453 that are spaced apart by an amount substantially equivalent to that defined by the crossbar 451 and the detent 452; a generally planar region is substantially bounded by these components that make up the tray 450, and may define either a solid surface, an open area or something embodying aspects of both such that all variants are within the scope of the present disclosure.

Referring with particularity to FIG. 5B, the MQRS 1 of FIG. 5A in an assembled state is shown. In it, the tray 450 has been pivotably engaged with its companion slotted pivot mount 441. Because the slotted pivot mount 441 also permits translational movement of the tray 450, once the tray 450 is engaged at the first end 450A as shown, it may be slid in a direction that is generally parallel to the second axis of engagement A_{S} until the detent 452 situated at the second end 450B is able to then be rotated (as shown by the arrow) to loop up and around clasp 442. Once the tray 450 is secured to the pair of engaging regions 440, the locking pin 610B may be inserted (such as by a threaded, tapered or other suitable fit with the pin-receiving apertures 454 and 630B) into the region adjacent the clasp 442 to affix the MQRS 1. In operation, to close the clip assembly 100 (such as around a strap or piece of MOLLE-style webbing), the tray 450 is slid forward in the slotted pivot mount 441, and then rotated upward in the manner shown. Once the strap to be engaged (not shown) is secured within the web-engaging channel 460 and the tray 450 is placed into a closed position through is engagement with the pair of engaging regions 440, the thickness of the strap forces the tray 450 downwardly, which in turn presses against the engaging regions 440 that results in friction fits that reduce the likelihood of an inadvertent unhinging of the tray 450 during use.

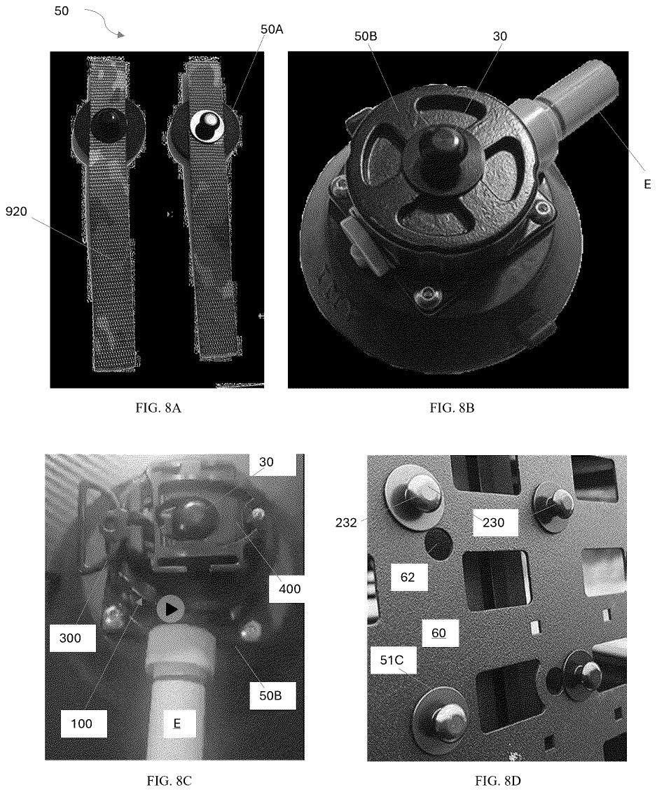

Referring next to FIGS. 6A through 6D, the clip assembly 100 according to another aspect of the present disclosure is shown. In one form, this embodiment of the clip assembly 100 is used in conjunction with, or as part of an equipment mounting system that will be discussed in more detail in herein, as well as in conjunction with FIGS. 8A through 10D.

Referring with particularity to FIGS. 6A and 6B, the peg 30 is shown in conjunction with other components that make up the clip assembly 100, where FIG. 6A depicts an exploded view as in a disassembled state and FIG. 6B depicts an assembled state. While many of the components making up the top cover 200, handle 300, cradle 500 and locking assembly 600 are the same, the base 400 exhibits other features that allow it to particularly engage the peg 30. Most notably, rather than having the pair of laterally-extending web clasps 430 as shown in FIGS. 1A through 1D, 2A through 2D, 3A, 3B, 4A and 4B, the base 400 (while still defining a unitary structure) now includes a lowermost cup-like (or bowl-like) extension 431 along the first axis of engagement A_{F}. The extension 431 includes an axisymmetric-shaped outer surface 431_{O} and an inner surface 431_{I} defining a non-axisymmetric-shaped fastener seating region. By shaping and sizing the fastener seating region of the inner surface 431_{I} to allow a relatively close-fit with the head 33B, the faceted surfaces of the fastener seating region act like a wrench to prohibit rotational movement of the screw-shaped head 33B. Because the threads of the bolt allow it to be in selective threaded engagement with the distal end 32B of the support post 32, upon such threaded engagement, the fastener seating region of the inner surface 431_{I} of the lowermost extension 431 retains at least the screw-shaped head 33B so that the MQRS 1 may—upon being secured to a mounting surface—remain in a relatively invariant rotational position.

Referring with particularity to FIG. 6C, the peg 30 of FIGS. 1G, 1H, 6A and 6B is shown being secured to a vehicle logistics track (L-track) 40 so that the peg 30 acts as a structural mounting intermediary between the L-track 40 and the remainder of the MQRS 1. It will be appreciated that although the peg 30 is shown connected to the L-track 40, it can instead be connected to a bracket or other mounting structure that is configured to cooperate with the support post 32, engagement region 34 and coil spring 38 of peg 30 that in turn may be made to cooperate with the remainder of MQRS 1 through the appropriate choice of head 33.

The L-track 40 includes a continuous, elongate channel 41 with periodically-spaced engagement zones 42 that are separated by intermediate narrowed-down neck zones 43. The channel 41 extends along the length of the L-track 40 (which coincides with the horizontal x-axis as shown, but can be oriented in any suitable position) and is sized to lockably engage the stop 32C and the mounting surface 31 to resist the outward (that is to say, z-axis) removal of the peg 30 as long as the peg 30 is not aligned with one of the engagement zones 42. As can be seen, the engagement zones 42 are formed in an upper portion of the channel 41 and define a generally circular profile that is larger than that of the stop 32C while the neck zones 43 are also formed in an upper portion of the channel 41 in a manner that is generally co-planar with the engagement zones 42. The neck zones 43 are shaped to define a pair of parallel surfaces that are horizontally-spaced by an amount that is greater than the width of the support post 32 but not as great as a track-engaging portion (that is to say, lower surface) of the engagement region 34. In this way, when a bias or other force that has a tendency to secure the peg 30 to the L-track 40 is present (such as through coil spring 38), the stop 32C and lower surface of the engagement region 34 cooperate to clamp the peg 30 to the portion of the neck zone 43 that is situated therebetween.

As previously discussed in conjunction with FIGS. 1G and 1H, the downwardly-projecting legs 37—along with the stop 32C of support post 32 and the lower surface of the engagement region 34 as just discussed—make up the track-engaging portion of the peg 30. The shape of the legs 37 within the Cartesian coordinate space shown is such that when a user is attempting to secure the peg 30 to the L-track 40, the peg 30 may be placed directly over one of the engagement zones 42 after which the user may press down on the head 33 so that the bias of coil spring 38 is overcome to allow the support post 32 to move downward relative to the engagement region 34 and L-track 40. Once the stop 32C clears the thickness of the upper portion of the channel 41, the user may slide the peg 30 away from the current engagement zone 42 along the channel 41 until the peg 30 is directly over an adjacent one of the neck zones 43. Once in position over a desired one of the neck zones 43, the engagement region 34 may (using, for example, the user-graspable handles 35) be rotationally placed such that the opposing legs 37 are aligned with one another to be spaced apart along the elongated direction defined by channel 41. In this way, while the head 33, coil spring 38 and most of the support post 32 (excepting of course the distal end 32B and the stop 32C both of which are adjacent a lower portion of the channel 41) are situated directly over the corresponding neck zone 43, the legs 37 are situated in the two adjacent engagement zones 42. Upon a release by the user of the peg 30, the bias force provided by the coil spring 38 forces the previously-discussed clamping action such that this force, coupled with the interference fit formed between the legs 37 and the upper portion of the channel 41 that corresponds to the engaged one of the neck zones 43, secures the peg 30 in place to create a particular tie-down point on the L-track 40. To remove the peg 30 from the L-track 40, the reverse of the previously-discussed steps is employed.

Referring next to FIG. 6D, a perspective view of how the pegs 30 of FIG. 1E may be attached to the L-track 40 and used in conjunction with extenders (also referred to herein as extension rails) 70 to provide more bag-mounting surface. Significantly, the extenders 70 may be used for configurations where the L-track was designed into the vehicle V, as well as part of a retrofit kit that may allow the L-track to be adapted onto a legacy vehicle V.

As will be discussed in conjunction with FIGS. 8A through 10D, the L-track 40 itself may be securely mounted to other surfaces, such as a wall of a building or a wall of a vehicle V. It will be appreciated that although the term “L-track” is used to describe the rail-like structure of the present disclosure, other forms of related track (such as a universal track, E-track, A-track or the like) may also be used in conjunction with the pegs 30 and the MQRS 1 that are disclosed herein. All such variants are deemed to be within the scope of the present disclosure.

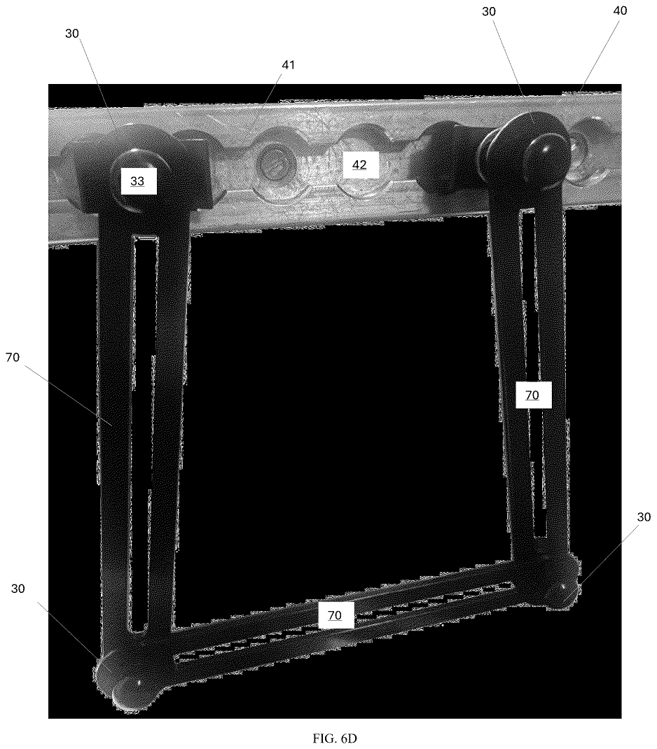

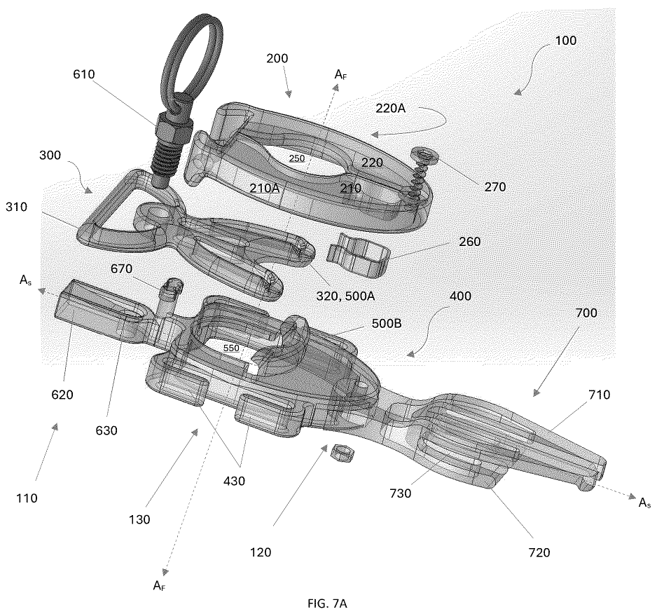

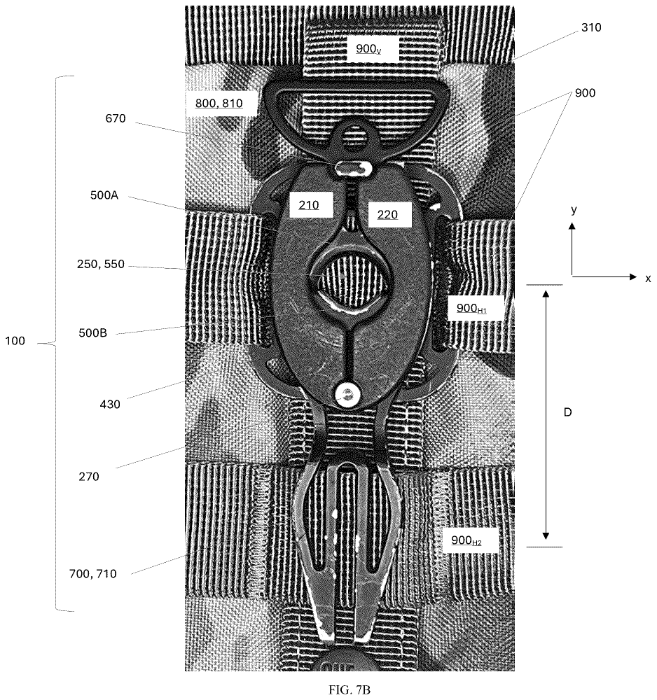

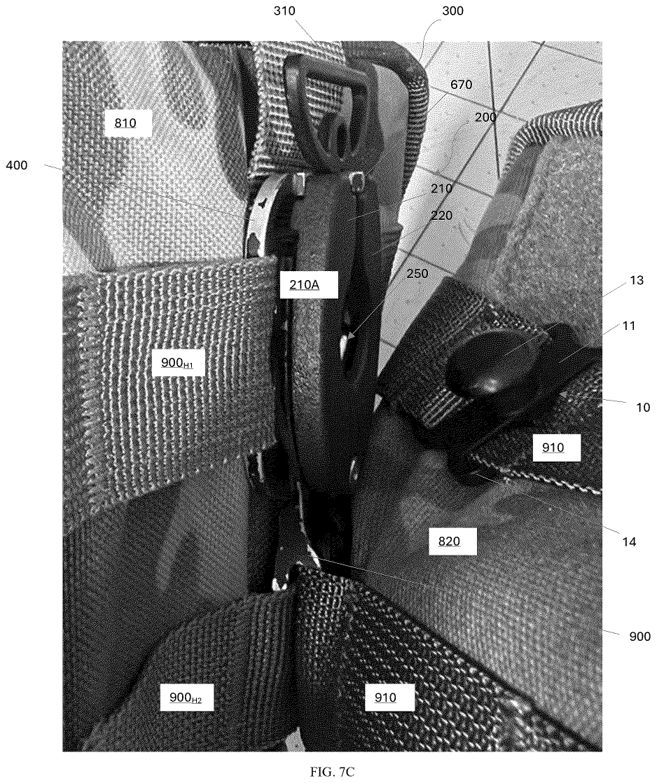

Referring next to FIGS. 7A through 7C, the clip assembly 100 is shown with an additional attachment. Although this attachment is shown in conjunction with the version of the clip assembly 100 that is depicted in FIGS. 7A through 7C, it will be appreciated that it may be used in conjunction with the version of the clip assembly 100 that is the other figures as well.

Referring with particularity to FIG. 7A, a perspective view in a disassembled state and prior to engagement with one of the pegs 10, 20, 30 is shown. As can be seen, most of the construction is the same as that which is discussed in conjunction with FIGS. 1A through 2D. What differs is the presence of an extender clasp 700 that includes an upper portion 710 and a lower portion 720 spaced apart from one another to define a web-engaging channel 730 between them. In one form, the extender clasp 700 is of one-piece (unitary) construction and made from a rigid, durable material, such as a lightweight metal or a structural polymer. As shown, the extender clasp 700 may in one form be secured to the distal end 120 of the clip assembly 100 through known fastening means, while in another form as being integrally formed with the base 400. The upper portion 710 and the lower portion 720 define a fork-like profile where the upper portion 710 projects farther along the distal direction of the second axis of engagement A_{S} than the lower portion 720, whereas the spacing defined between the upper portion 710 and the lower portion 720 along an axis parallel to the first axis of engagement A_{F} corresponds to the web-engaging channel 730. In one form, this spacing is of sufficient height to permit both a web (such as the MOLLE-style webbing discussed elsewhere and as follows) and a strap (such as that which is stitched into, adhered to or otherwise affixed to a secondary (or accessory) bag or container) to be relatively easy to insert into or removed from the web-engaging channel 730.

Referring with particularity to FIGS. 7B and 7C, respective front elevation and perspective views show how this embodiment of the clip assembly 100 is capable of additional securing to a web 900 (also referred to herein as MOLLE-style web or MOLLE-style webbing) that in turn is secured to surfaces of bags 800, vests, containers or other web-engaging structure. As with the previously-discussed heads 33 of FIGS. 1E through 1H, the bags 800 may include different embodiments, including (as shown) a primary bag 810 and a secondary bag 820. It will be appreciated that the web 900 that is shown as being stitched, adhered or otherwise affixed to the primary bag 810 may (although not shown) be similarly attached to a vest or other wearable garment, apparel or container, and that all such variants are within the scope of the present disclosure. Likewise, references to torso-mountable bags such as primary bag 810 will also be understood to include such torso-mountable vests and related garments, apparel or containers unless the context dictates a greater level of specificity. Within the present disclosure, the primary bag 810 may be a relatively large bag, such as one that is mounter to a user's torso, while the secondary bag 820 may be a relatively small bag configured to contain smaller items (including those for a single purpose, such as a first aid kit, a vaccine supply, ammunition or the like). Given the relatively small size of the secondary bag 820, it is envisioned that it may fit—along with one or more similarly-sized or smaller bags—onto the primary bag 810 through multiple mounting locations as dictated by the web 900 which as shown may extend in a grid-like pattern across the surface of the primary bag 810 in horizontal (x-axis) and vertical (y-axis) directions. One example of a gridded web approach of webbing sewn into or otherwise affixed to load-bearing vests, jackets and other apparel along with companion webbing and straps on a bag or container to be attached and which may be used with the MQRS 1 is known as a pouch attachment ladder system (PALS), which uses the MOLLE-style of webbing discussed herein.

Referring with particularity to FIG. 7B, the front elevation view shows how the extender clasp 700-equipped MQRS 1 embodiment (with the peg 10 presently removed for clarity) is secured to a portion of the grid of web 900. In it, a first horizontal web row 900_{H1} may be made to engage with the web clasps 430 so that at least the clip assembly 100 part of the MQRS 1 is secured to the primary bag 810. The vertical spacing D between centerlines of the first horizontal web row 900_{H1} and an immediately adjacent second horizontal web row 900_{H2} is sized to generally coincide with the distance between the portion of the clip assembly 100 that defines the cover opening 250 and the cradle opening 550. The extender clasp 700 accepts the second horizontal web row 900_{H2} into the web-engaging channel 730. By having the two consecutive horizontal web rows 900_{H1}, 900_{H2} of the primary bag 810 engage with the MQRS 1, additional security of attachment between the primary bag 810 and the secondary bag 820 of FIG. 7C is promoted. Depending on the end-use (such as those that may require a mounting configuration that requires the secondary bag 820 or related container being attached to be in an orientation that is rotated 90°), a vertical web row 900_{V} may be made to engage with the web clasps 430 in a manner similar to that of the first horizontal web row 900_{H1}.

Referring with particularity to FIG. 7C, a perspective view of the MQRS 1 of FIG. 7B just prior to engagement with peg 10 is shown. As can be seen, the peg 10 is separately secured to the secondary bag 820 via strap 910 that in one or more of weave, materials, dimension or other indicia of construction may resemble the MOLLE-style web 900. Because the engagement region 14 of peg 10 generally resembles the web clasps 430 of the base 400, the method of securing them to their respective web or strap is similar. As discussed previously in conjunction with FIG. 4B, tugging the user-grippable first portion 310 of the handle 300 vertically upward in the orientation depicted in FIG. 7C, the cover opening 250 and the cradle opening 550 expand from their respective first aperture sizes 250A, 550A to their second aperture sizes 250B, 550B. Once this is achieved, the aligned cover and cradle openings 250, 500 are of sufficient size to accept the head 13 of the peg 10 therein for engagement with the cradle 500. At this time, the handle 300 may be released such that the bias force of the arms 210 forces the side walls 210A, 220A to return to their resilient bias state, thereby causing at least the anvils 500A, 500B of the cradle 500 to return the cradle 500 to its first aperture size 550A that in turn results in it clamping down on the support post 12 to that the head 13 is locked into place. At this time, the secondary bag 820 is secured to the primary bag 810. In an alternative approach (not shown), the secondary bag 820 may be secured to the primary bag 810 using the MQRS 1 in a more direct manner by having the user forcibly press the head 13 along the first axis of engagement A_{F} through the cover opening 250 and against the beveled surfaces that are shown in FIGS. 1C, 2B and 2C and which define the peg-facing surface of the first and second anvils 500A, 500B. This approach, which is more of a brute-force approach, may be useful in emergency or tactical situations where the user has neither the time nor the inclination to attach the two bags 810, 820 together using the previously-discussed attachment approach. It will be appreciated that in situations where such brute-force use is expected to be used, additional material that makes up one or more of the components (such as the top cover 200, base 400 and cradle 500) that form the clip assembly 100 may be used, which in turn adds a concomitant amount of weight or bulk.

To remove the secondary bag 820 from the primary bag 810, the user again pulls the user-grippable first portion 310 of the handle 300 vertically upward in the orientation depicted in FIG. 7C while simultaneously pulling the secondary bag 820 away from the primary bas 810 until the head 13 is clear of the cover and cradle openings 250, 550.

Referring next to FIGS. 8A through 11B, various embodiments of the MVAS 1000 are shown. As can be seen, a termination point of the MVAS 1000 resembles one or more of the pegs 10, 20, 30 that are disclosed herein. Within the present disclosure, the termination point corresponds to the location on the MVAS 1000 where the actual secure connection is taking place between it and the bag 800 or related container. For example, if a user is attempting to attach the primary bag 810 and clip assembly 100 of either FIGS. 4A and 4B or 7B and 7C to any of the configurations of the MVAS 1000 that are depicted in FIGS. 8A through 10D, the termination point would correspond to the location where the cradle 500 of the clip assembly 100 securely holds the head 13, 23, 33 of the respective peg 10, 20, 30 in place by the locking mechanisms disclosed herein.

The MVAS 1000 provides numerous attachment options for vehicular use, such as those associated with military vehicles (including special operations forces (SOF) vehicles), indigenous vehicles, construction vehicles, emergency medical services (EMS) vehicles, ambulances or the like. As can be seen, by having directly-exposed user-accessible heads 13, 23, 33 projecting outward from a mounting surface such as those shown, a user may quicky attach or remove one or more bags 800, including rucksacks 800A, vests 800B, hardcases 800C and other attachable bags, containers or the like (such as bags 800D that are commonly used by military personnel, EMS workers, backpackers or the like.

Referring with particularity to FIGS. 8A, 8B and 8C, two primary attachments 50 are shown for securing the MVAS 1000 to a vehicle, as well as an example engagement between one of the attachments 50 and the MQRS 1. In FIG. 8A, one attachment 50 is configured as a magnetic attachment 50A that is secured to either a lowermost surface of the peg 30 of FIGS. 1G and 1H or (in the case of a separate head 33A), to the lowermost portion of the mounting surface 31. In such construction, the attachment 50 may be secured to numerous magnet materials, including those used to make vehicular panels or wall structures, such as cold-rolled steel, martensitic stainless steel and ferritic stainless steel. As can be seen, the magnetic attachment 50A may be formed into a larger assembly, such being secured to a strap 920 that in one form is constructed out of webbing similar to that previously discussed. In FIG. 8B, the attachment 50 is configured as a vacuum-based attachment 50B that is also secured to either a lowermost surface of the peg 30 of FIGS. 1G and 1H or (in the case of a separate head 33A), to the lowermost portion of the mounting surface 31. In such construction, the vacuum-based attachment 50B may be secured to any hard surface so long as the mounting location is generally planar or in any shaped suitable to ensure an airtight fit. An evacuation line 51 is placed in fluid communication with a portion of the vacuum-based attachment 50B to ensure that a volumetric space that is formed between the vacuum-based attachment 50B and the surface being attached may be selectively subjected to a low-pressure environment from a vacuum source (such as a pump or the like) that is coupled to the vacuum-based attachment 50B through the evacuation line E. In FIG. 8C, the MQRS 1 with an embodiment of the clip assembly 100 and peg 30 is shown engaged with the vacuum-based attachment 50B of FIG. 8B.

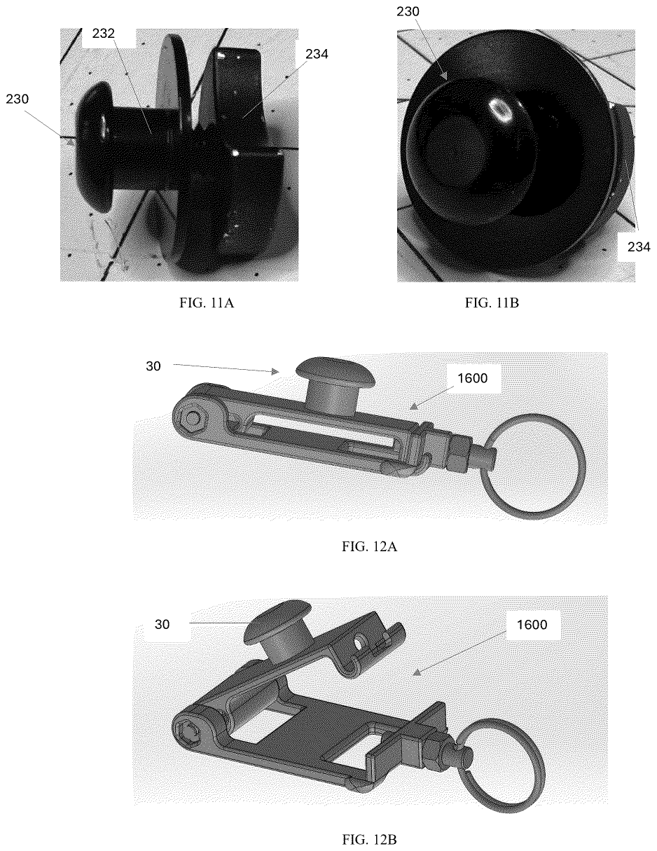

Referring with particularity to FIG. 8D in conjunction with FIGS. 11A and 11B, a peg board 60 (also referred to as a MOLLE board) that can form an extended wall is shown with another embodiment of the pegs 230 in place. While an attachment portion 232 of peg 230 that engages the clip assembly 100 (not presently shown) resembles aspects of the mounting surface 31 and interchangeable head 33A of the peg 30 of FIGS. 1G and 1H, the present peg 230 may be secured to hard surfaces that have suitably-configured apertures such as aperture 62, including those surfaces that define hard cases, walls or the like, particularly those made of rigid materials such as metal. As can be seen, the peg 230 can be surface-mounted in a generally flush manner on the wall of a vehicle V or indirectly through the peg board 60 (which in turn may be mounted to the vehicle V through known fastening or joining means). In the case of an indirect attachment to the vehicle V, the apertures 62 are sized to accept a backing portion 234.

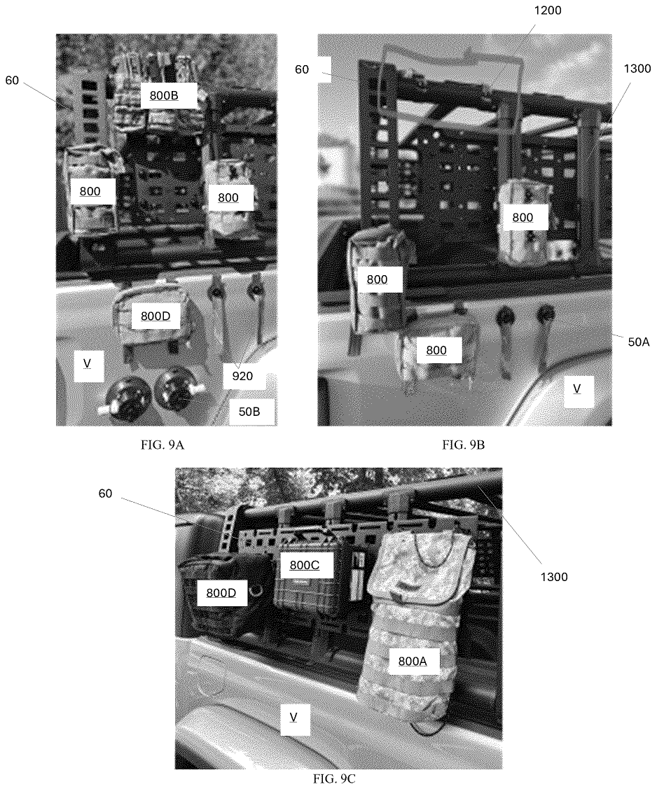

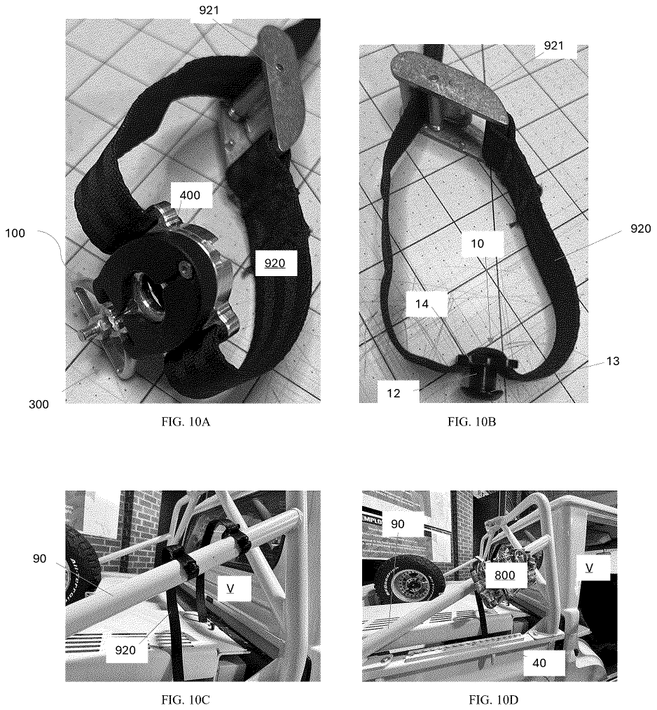

Referring with particularity to FIGS. 9A through 9C, various views of how bags 800—regardless of whether in a flexible form (such as a pouch, backpack, rucksack or the like) or rigid form (such as a hardcase like the Pelican-style protective cases)—are secured to a vehicle V either directly or indirectly using one or both of the MQRS 1 and MVAS 1000. As such, in one form the MVAS 1000 may be packaged along with one or more of the embodiments of the previously-discussed MQRS 1. Such packaging may include, in addition to numerous clip assemblies 100, numerous pegs 10, 20, 30, a wrench (such as an Allen key wrench or the like), a suite of MVAS 1000 attachments (such as the magnetic and non-magnetic variants that are discussed in conjunction with FIGS. 8A and 8B), multiple rails (such as Airline Track, L-Track as shown in FIG. 6C or an equivalent), rail attachments (such as shown in conjunction with FIG. 9B), one or more MOLLE board pegs and extensions (such as L-track extensions or mini L-track extensions of FIG. 6D). In a similar manner, in one form the MQRS 1 may form a subsystem or subassembly of the MVAS 1000 as will be discussed in conjunction with FIGS. 10A through 10D.

Although the bags 800 shown in FIGS. 9A through 9C are tactical MOLLE utility pouches or bags (including bags 800D for organizing tools, medical supplies or the like, as a well as the Pelican™-style hard case 800C), it will be appreciated that other bag configurations may be used, and that all such variants are within the scope of the present disclosure. As shown with particularity in the highlighted region of FIG. 9B, rail attachments 1200 are arranged to be secured to a top rail (whether of tubular, rectangular, L-bracket or other such load-bearing shape) that is affixed to or otherwise extends from the vehicle V (presently shown as a pickup truck, but applicable to other vehicles as well), as well as to one or more of the peg bards 60. In one form, the rail may form a part of an overland (or overlanding) rack 1300.

It will be appreciated that although the present views depict the use of the such attachment taking place on exterior surfaces of the vehicle V (including, as shown, on or around a truck bed), the embodiments of the devices, systems and components discussed herein are equally applicable to the interior of vehicle V. As can be seen, the modular nature of such attachment—as long as the ability to quickly and securely engage and disengage the various bags, cases (both hard- and soft-sided variants) and related containers (whether of flexible or rigid construction and collectively referred to as equipment)—may be adapted to various vehicles, regardless of vehicle make or model. In one form, the MQRS 1 and MVAS 1000 are configured to hold heavy object, including those that weigh up to 400 pounds or more.

Referring next to FIGS. 10A through 10D, the MQRS 1 may form a subsystem or subassembly of the MVAS 1000 such that two cooperate together in order to perform their bag-or container-securing function. In form, the straps 920 (such as those shown in FIGS. 7B, 7C, 8A and 9A) are particularly useful for situations where modification of one or both of an interior and exterior of the vehicle V (such as through the inclusion of cages, rollbars or other tubular structure 90) permit numerous locations for the ad hoc mounting of the bags 800. The inclusion of the clip assembly 100 and the peg 10 on separate places on the strap 920, along with the inclusion of a strap tie-down 921 (all as shown with particularity in FIGS. 10A and 10B), allows one or more bags 800 to be secured to any convenient location on the vehicle V through the straps 920 and tubular structure 90 (as shown in FIGS. 10C and 10D). As shown with particularity in FIG. 10D, L-track 40 may be mounted onto the vehicle V in numerous locations, including those where the channel 41, engagement zones 42 and neck zones 43, are oriented to face vertically upward (as shown) or downward.

Referring next to FIGS. 12A and 12B, as previously discussed, a variation of the peg 20 of FIG. 1F may be outfitted with a locking assembly 1600. In construction, the locking assembly 1600 is generally similar in construction to the locking assembly 600 (in general) and the slotted pivot mount 441 and clasp 442 (in particular) where the former is both rotationally and translationally secured to allow the latter to be latched into place in order to hold a flat object (sech as a section of strap 920 of FIGS. 10A through 10D or the web (such as the MOLLE webbing) 900 of FIGS. 4A, 4B, 7B and 7C in between.

Within the present disclosure, one or more of the following claims may utilize the term “wherein” as a transitional phrase. For the purposes of defining features discussed in the present disclosure, this term is introduced in the claims as an open-ended transitional phrase that is used to introduce a recitation of a series of characteristics of the structure and should be interpreted in like manner as the more commonly used open-ended preamble term “comprising” and its variants that do not preclude the possibility of additional acts or structures.

Within the present disclosure, terms such as “preferably”, “generally” and “typically” are not utilized to limit the scope of the claims or to imply that certain features are critical, essential, or even important to the disclosed structures or functions. Rather, these terms are merely intended to highlight alternative or additional features that may or may not be utilized in a particular embodiment of the disclosed subject matter. Likewise, it is noted that the terms “substantially” and “approximately” and their variants are utilized to represent the inherent degree of uncertainty that may be attributed to any quantitative comparison, value, measurement or other representation. As such, use of these terms represents the degree by which a quantitative representation may vary from a stated reference without resulting in a change in the basic function of the subject matter at issue.

Within the present disclosure, the use of the prepositional phrase “at least one of” is deemed to be an open-ended expression that has both conjunctive and disjunctive attributes. For example, a claim that states “at least one of A, B and C” (where A, B and C are definite or indefinite articles that are the referents of the prepositional phrase) means A alone, B alone, C alone, A and B together, A and C together, B and C together, or A, B and C together. By way of example within the present disclosure, if a claim recites that data is being acquired from at least one of a first sensor, a second sensor and a third sensor, and if such data is being acquired from the first sensor alone, the second sensor alone, the third sensor alone or any combination of the first, second and third sensors, then such data acquisition satisfies the claim.

Within the present disclosure, the following claims are not intended to be interpreted based on 35 USC 112(f) unless and until such claim limitations expressly use the phrase “means for” or “steps for” followed by a statement of function void of further structure. Moreover, the corresponding structures, materials, acts and equivalents of all means or step plus function elements in the claims that follow are intended to include any structure, material or act for performing the function in combination with other claimed elements as specifically claimed.

Within the present disclosure, the singular forms “a,” “an” and “the” include plural references unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6 to 9, the numbers 7 and 8 are contemplated in addition to 6 and 9, and for the range 6.0 to 7.0, the number 6.0, 6.1, 6.2, 6.3, 6.4, 6.5, 6.6, 6.7, 6.8, 6.9 and 7.0 are explicitly contemplated.

Within the present disclosure, one or both of the description and claims may use several geometric or relational terms such as circular, curved, planar, linear, elongated, rounded, flat or the like. In addition, one or both of the description and claims may use several directional or positioning terms such as top, bottom, inwardly, outwardly, inner, outer, distal and proximal. Those terms are merely for convenience to facilitate the description based on the embodiments shown in the figures, and as such are not intended to limit the scope of the features disclosed herein. Thus, it should be recognized that such features may be described in other ways without recourse to any such geometric, relational, directional or positioning terms. In addition, the geometric or relational terms may not be exact. For instance, walls or surfaces may not be exactly circular to one another but still be considered to be substantially circular because of, for example, roughness of surfaces, tolerances allowed in manufacturing or other practical limitations. Furthermore, other suitable geometries and relationships may be provided without departing from the spirit and scope of the disclosed subject matter.

Having described the subject matter of the present disclosure in detail and by reference to specific embodiments, it is noted that the various details disclosed in the present disclosure should not be taken to imply that these details relate to elements that are essential components of the various described embodiments, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure may be identified as preferred or particularly advantageous, it is contemplated that the present disclosure is not necessarily limited to these aspects.

It will be apparent to those skilled in the art that various modifications and variations can be made to the described embodiments without departing from the spirit and scope of the claimed subject matter. Thus it is intended that the specification cover the modifications and variations of the various described embodiments provided such modification and variations come within the scope of the appended claims and their equivalents.

What is claimed is:

1. A modular quick release system comprising:
a peg comprising a mounting surface from which extends, along a first axis of engagement, a support post that terminates in a head, the head defining a larger lateral surface area than the support post; and
a clip assembly having a proximal end, a distal end and a peg-receiving region disposed between the proximal and distal ends, the clip assembly comprising:
a top cover comprising a plurality of arms situated adjacent one another to define a top cover upper surface and which are pivotably secured to one another adjacent the distal end, the plurality of arms defining between them a cover opening that forms a portion of the peg-receiving region along the first axis of engagement;
a handle alignable with the top cover to move between the proximal and distal ends along a second axis of engagement that is orthogonal to the first axis of engagement, the handle comprising a user-grippable first portion adjacent the proximal end and a second portion adjacent the peg-receiving region;
a base secured to the top cover and handle; and
a cradle that defines a cradle opening therein that is aligned with the cover opening along the first axis of engagement to form a portion of the peg-receiving region, wherein both the cover opening and the cradle opening are adjustable to define a first aperture size when the plurality of arms are in a resilient bias state and a second aperture size when the plurality of arms are in a displaced state relative to their resilient bias state, the first aperture size of each of the respective cover and cradle openings defining a smaller cross-sectional area than the second aperture size and further wherein the first aperture size of the cradle opening is such that if the peg is (i) not already inserted into the peg-receiving region, the cradle blocks insertion of the peg therein along the first axis of engagement, or (ii) already inserted into the peg-receiving region, the cradle blocks removal of the peg therefrom along the first axis of engagement, wherein the top cover, base and handle are cooperative with one another such that upon movement of the handle toward the proximal end, the resilient bias state is overcome to cause the first aperture size of at least the cradle opening to transition to its second aperture size such that the peg may be selectively inserted into or removed from the peg receiving region along the first axis of engagement along with corresponding engagement with or disengagement from the cradle.

2. The modular quick release system of claim 1, wherein the first aperture size of the cradle opening defines a smaller cross-sectional area than the first aperture size of the cover opening.

3. The modular quick release system of claim 2, wherein the cross-sectional area defined by the first aperture size of the cradle opening is greater than the support post but smaller than the head such that upon insertion of the head into the cradle and a return of the plurality of arms to the resilient bias state, the peg and the clip assembly form a locking relationship with one another.

4. The modular quick release system of claim 3, wherein the cross-sectional area defined by the second aperture size of the cradle opening is greater than the head.

5. The modular quick release system of claim 1, wherein the first aperture size of the cover opening is such that if the peg is (i) not already inserted into the peg-receiving region, the top cover blocks insertion of the peg therein along the first axis of engagement, or (ii) already inserted into the peg-receiving region, the top cover blocks removal of the peg therefrom along the first axis of engagement.

6. The modular quick release system of claim 1, further comprising a locking assembly cooperative with the clip assembly and comprising:
a removable locking pin;
a locking mount formed within the base and defining a pin-receiving aperture therein with which to accept a portion of the locking pin; and
a locking surface formed within the handle and defining a pin-receiving aperture therein with which to accept a portion of the removable locking pin, wherein the removable locking pin, locking mount and locking surface are cooperative with one another such that when the plurality of arms are in the resilient bias state, placement of the removable locking pin within the respective locking mount and locking surface pin-receiving apertures immobilizes movement of the handle relative to the base in at least one of the first axis of engagement and the second axis of engagement.

7. The modular quick release system of claim 6, wherein when the plurality of arms are in the resilient bias state, the pin-receiving apertures of the respective locking surface and locking mount are aligned along a direction that is parallel to the first axis of engagement.

8. The modular quick release system of claim 7, wherein both the removable locking pin and the pin-receiving aperture defined within the locking mount define a threaded surface along at least a portion of their respective lengths with which to threadably engage each other.

9. The modular quick release system of claim 6, wherein the handle is rotationally removable from the remainder of the clip assembly through a pivot structure that is formed between the handle and the base.

10. An equipment mounting system comprising:
a track that defines an elongate peg-engaging channel therein along its lengthwise dimension, the peg-engaging channel defining a plurality of engagement zones along the lengthwise dimension; and
a modular quick release system cooperative with the track, the modular quick release system comprising:
a peg comprising a mounting surface from which extends, along a first axis of engagement, a support post that terminates in a removable head that defines a larger lateral surface area than the support post, wherein the support post and head are resiliently-biased relative to the mounting surface to permit selective movement of the support post and head along the first axis of engagement; and
a clip assembly having a proximal end, a distal end and a peg-receiving region disposed therebetween, the clip assembly comprising:
a top cover comprising a plurality of arms situated adjacent one another to define a top cover upper surface and which are pivotably secured to one another adjacent the distal end, the plurality of arms defining between them a cover opening that forms a portion of the peg-receiving region along the first axis of engagement;
a handle alignable with the top cover to move between the proximal and distal ends along a second axis of engagement that is orthogonal to the first axis of engagement, the handle comprising a user-grippable first portion adjacent the proximal end and a second portion adjacent the peg-receiving region;
a base secured to the top cover and handle, the base defining a unitary structure with a lowermost extension along the first axis of engagement, the lowermost extension comprising an axisymmetric-shaped outer surface and an inner surface that defines a non-axisymmetric-shaped fastener seating region wherein upon engagement between the peg and clip assembly, the lowermost extension retains at least an upper portion of the head in the non-axisymmetric-shaped fastener seating region; and
a cradle that defines a cradle opening therein that is aligned with the cover opening along the first axis of engagement to form a portion of the peg-receiving region, wherein both the cover opening and the cradle opening are adjustable to define a first aperture size when the plurality of arms are in a resilient bias state and a second aperture size when the plurality of arms are in a displaced state relative to their resilient bias state, the first aperture size of each of the respective cover and cradle openings defining a smaller cross-sectional area than the second aperture size, wherein the base and handle are cooperative with one another such that upon movement of the handle toward the proximal end, the resilient bias state is overcome to cause the first aperture size of both the cover and cradle openings to transition to their respective second aperture size such that the peg may be selectively inserted into or removed from the peg receiving region along the first axis of engagement along with corresponding engagement with or disengagement from the cradle.

11. The equipment mounting system of claim 10, wherein the track comprises a universal rail.

12. The equipment mounting system of claim 10, wherein the track comprises an L-track.

13. The equipment mounting system of claim 10, wherein the plurality of engagement zones are continuously interconnected with one another and separated by neck zones along the lengthwise dimension.

14. The equipment mounting system of claim 10, further comprising at least one extender that defines at least one aperture formed therein along an elongate dimension, the at least one aperture configured to selectively engage the peg at a location between the proximal and distal ends of the support post.

15. The equipment mounting system of claim 14, wherein the at least one aperture comprises a plurality of apertures therein at least one of which coextends along the elongate dimension of the extension rail.

16. An equipment mounting system comprising:
a peg board that defines at least one aperture therein;
a peg securable to the peg board through the aperture, the peg comprising a mounting surface from which extends, along a first axis of engagement, a support post that terminates in a removable head that defines a larger lateral surface area than the support post; and
a modular quick release system securable to the peg board through the peg, the modular quick release system comprising a clip assembly having a proximal end, a distal end and a peg-receiving region disposed therebetween, the clip assembly comprising:
a top cover comprising a plurality of arms situated adjacent one another to define a top cover upper surface and which are pivotably secured to one another adjacent the distal end, the plurality of arms defining between them a cover opening that forms a portion of the peg-receiving region along the first axis of engagement;
a handle alignable with the top cover to move between the proximal and distal ends along a second axis of engagement that is orthogonal to the first axis of engagement, the handle comprising a user-grippable first portion adjacent the proximal end and a second portion adjacent the peg-receiving region;
a base secured to the top cover and handle; and
a cradle that defines a cradle opening therein that is aligned with the cover opening along the first axis of engagement to form a portion of the peg-receiving region, wherein both the cover opening and the cradle opening are adjustable to define a first aperture size when the plurality of arms are in a resilient bias state and a second aperture size when the plurality of arms are in a displaced state relative to their resilient bias state, the first aperture size of each of the respective cover and cradle openings defining a smaller cross-sectional area than the second aperture size, wherein the base and handle are cooperative with one another such that upon movement of the handle toward the proximal end, the resilient bias state is overcome to cause the first aperture size of both the cover and cradle openings to transition to their respective second aperture size such that the peg may be selectively inserted into or removed from the peg receiving region along the first axis of engagement along with corresponding engagement with or disengagement from the cradle.

17. A modular vehicle attachment system comprising:
a peg-shaped attachment comprising a mounting surface from which extends, along a first axis of engagement, a support post that terminates in a removable head that defines a larger lateral surface area than the support post, wherein the support post and head are resiliently-biased relative to the mounting surface to permit selective movement of the support post and head along the first axis of engagement; and
a securing mechanism formed on a surface of the peg-shaped attachment that is proximal relative to the head along the first axis of engagement.

18. The modular vehicle attachment system of claim 17, wherein the securing mechanism comprises a magnetic mounting surface.

19. The modular vehicle attachment system of claim 17, wherein the securing mechanism comprises a vacuum-based mounting surface.

20. The modular vehicle attachment system of claim 17, further comprising a strap with at least one aperture defined therein to selectively engage the peg-shaped attachment at a location between the proximal and distal ends of the support post.
